(19) United States
(12) Patent Application Publication
(10) Pub. No.: US 2019/0240889 A1
(43) Pub. Date: Aug. 8, 2019

(54) METHOD AND DATA DETECTION DEVICE FOR PROVIDING, RETRIEVING AND USING A DATA ELEMENT IN A PROCESS FOR PRODUCING PLASTIC SHEET MATERIAL

(71) Applicant: Reifenhaeuser GmbH & Co. KG Maschinenfabrik, Troisdorf (DE)

(72) Inventors: Christoph Lettowsky, Aachen (DE); Thomas Fett, Troisdorf (DE); Mark Hilgers, Troisdorf (DE); Jens Mager, Koeln (DE); Andreas B. Roesner, Bonn (DE); Christian Stelter, Ingelheim (DE); Asmir Vodencarevic, Fuerth (DE); Paul Walach, Troisdorf (DE); Hans-Geong Geus, Niederkassel (DE)

(21) Appl. No.: 16/342,370

(22) PCT Filed: Oct. 18, 2017
(86) PCT No.: PCT/DE2017/000350

§ 371 Date: Apr. 16, 2019

(30) Foreign Application Priority Data
Oct. 18, 2016 (DE) 10 2016 012 479.2

(51) Int. Cl. B29C 48/92; G05B 19/418

(52) U.S. Cl. CPC B29C 48/92; G05B 19/41875; G05B 2219/32368; B29K 2101/12; G05B 2219/31376; B29C 2948/92295; B29C 2948/9279; G05B 2219/45234

(57) ABSTRACT

The invention relates to various aspects in the production and further processing of plastic sheet material, in particular a spun-bonded non-woven fabric, a melt-blown non-woven fabric, a composite non-woven fabric, a blown film, a flat film, a plastic board or a plastic panel. A core aspect in the value chain of sheet material is a method and device for providing, retrieving and using a data element for exchanging in an over-lapping step-wise manner, a plurality of different data elements for producing the end product within the value chain of the sheet material. Within the value chain, it is possible to optimize the method using said data, to improve the construction of the used machines and systems and to improve the system technology as well as method technology for producing the sheet material.

The invention relates to a method for providing, retrieving and using a data elements, a method for classifying, a use of data for constructing of a machine, a method for improving a quality of a process, a method for producing a plastic sheet material/product (German: Bahnware), an electronic data detection device and a plant for producing a plastic sheet material.

In particular, the invention relates to a method for providing, retrieving and using a data element in the value chain/value creation chain of a plastic sheet material for producing a final product by means of a communication protocol and a data carrier for the over-lapping step-wise manner/step crossing exchange of a plurality of different data elements for producing the end final product within the value chain, a use of data to design a production machine or a processing machine, a process for improving the quality of a process, in particular of a production process, a logistics process or a management processes within the value creation chain of plastic sheet materials for producing a final product, whereby the data element is retrievable and usable by means of the communication protocol and the data carrier for the over-lapping step-wise manner exchange of a plurality of various data elements, a method for producing a plastic sheet material, wherein an extruder is used for plastifying a plastic, an electronic data detection device, for the step crossing providing, retrieving and using of a data element in the value creation chain of a plastic sheet material for producing a final product by means of a communication protocol for the over-lapping step-wise manner/step crossing exchange of a plurality of different data elements for producing the end product within the value creation chain and a plant for producing a plastic sheet material, whereby an extruder is used for plasticizing a plastic.

The value chains of industrial products are subject to a steadily increasing complexity. Through new and further developments in the raw materials, the material sciences, technologies and machines for the processing of raw materials, technologies and machinery for semi-finished products, technologies and machinery for processing semi-finished products, processes in logistics and not finally, the processes in the management of the value creation chain always result in a profound network of interdependent information.

The production and processing of plastic sheet material is currently subject to a great change. The possibilities for production of the sheet material to obtain desirable specific properties for the end customer are highly grow, so that the possible properties of the end products are more extensive and the end products are becoming more varied.

However, this technological progress requires equally an increasing degree of coordination within the value creation chain of plastic sheet materials.

Machines for the production of sheet materials require for the robust implementation of new product properties an increasing extent of coordination of the properties of the raw materials used. Equally, however, the machines for the further-processing of the sheet material must be coordinated on an in ever-increasing scale on the properties of the sheet materials.

The coordination processes, in particular, require an exchange of data which due to the increasing number of properties, must be adapted more and more to individualized products.

Further optimization within the value creation chain requires optimization of individual processes, which requires a higher degree of interaction between the actors in the value creation chain. This level of interaction can be reached as a result of steady increasing and accelerating depth of detail in the future only with methods and devices of the information technology.

It is therefore desirable for all actors within the value creation chain of plastic sheet material to get the relevant data of the other elements in the value creation chain, ideally, both, data before in the value creation chain and data later in the value chain, in simple words, data from both suppliers and from the customer. This requires the use of uniform standards of data communication.

The WO 2017/174232 A1 discloses a method for evaluating a process for producing a film web, wherein a correlation between the manufacturing process data and the further processing process data is produced in a film production.

The WO 2017/174223 A1 discloses an apparatus and a method for an industrial automated process, wherein a process data value is passed to one in the process upstream or downstream arranged single machine through an interface.

The DE 10 2016 014 690 A1 discloses a method in which a large amount of information about processes, taking place at the extrusion plant, are monitored to the operator person for operating the plant, wherein at least some information regarding the achievement of extrusion results of a first plant operator are displayed to at least one further operator in such a way that the extrusion plant operated by the at least one further operator is operated dependent from this information, thereby increasing the effectiveness of the extrusion process.

The invention is based on the object, to provide to the prior art an improvement or an alternative.

According to a first aspect of the invention, the object is solved by a method for the retrieval and use of a data element in the value creation chain of a plastic sheet material for producing a final product by means of a communication protocol and a data carrier for the over-lapping step-wise manner exchange of a plurality of different data elements to produce the final product within the value chain, wherein the data element is used in over-lapping step-wise manner within the value chain, namely from a first stage by means of the communication protocol provided on the data carrier and from a second stage by means of the communication protocol retrieved from the data carrier and used in a machine of the second-stage.

Conceptually, the following is explained:

First of all, it should be noted that within the scope of the present patent application indefinite articles and numbers such as “one”, “two” etc. normally should be understood as “at least” information, so as “at least one . . . ”, “at least two . . . ” etc., unless it is not expressed explicitly from the context or is obvious or technically imperative for the skilled person, that there can only be “exactly one” exactly two . . . “and so on.

A “data element” refers in particular to the singular of “data”. Under a “data element” is to understand an indication, a numeric value or, in general, an information that was obtained by measurement or observation. In particular, electronically provided information are called “data”. A data element is in this sense an electronic information. A “data element” is not on limited the type of information. In particular, it can be a number, a date, a name, a term or any other type of electronic information being present. A data element is limited to a single information. A data element may also have a plurality of information due to the context.

A “data element” can be accessed by means of an identifier. In particular, doing so, a data element can be loaded from the memory, in particular a location-independent data memory (database query) or stored in a data memory.

In particular, it is conceivable that a data element can be given or exchanged to a mobile data carrier.

An “information” is a subset of knowledge.

A “data carrier” is a physical or virtual device for storing data. A data carrier can be a “location-independent storage” or in the broadest sense be a “data cloud”, which in science and colloquially is called “cloud”. One task of the data carrier is to store efficiently large volumes of data, consistent and durable, and to provide necessary subsets of the stored data in different, needs-based forms of presentation for users and application programs. In a special embodiment the data carrier can cause a data transfer, but not a storage. This is, for example, in the case of computer network, in wireless or wired case.

A “location-independent store” is a data store/memory that is not dependent from a location is or bound in any way to a location. Rather, it is under a location-independent memory to understand a memory which is not stationary, in particular it is not be bound to a machine or a plant or to a production process or a production hall or a company or state territory or a value creation chain.

Under “providing” a data element it is understood the storage of information on a data carrier, so that it is retrievable. Under the “writing” a data element it is also understood the “providing” of a data element.

Under “retrieving” a data element it is understood the reading of an information on the data carrier, so that it is “usable” within networked systems.

Under “use” of a data element is meant the insertion of the information that contains the data element. For example, the information may be used within particular networked systems for controlling and/or optimizing the production processes, for controlling and/or optimizing the logistics processes or for controlling and/or for optimizing the management processes.

A “value creation chain” represents the “stages” of production as to string orderly activities together. These activities create creation values, consume resources and are interconnected in processes. Under “over-lapping step-wise manner/stage crossing” is meant that into the activity a plurality of steps are involved, especially in the exchange of data elements.

By “sheet material” is meant a relevant art of products, especially in webs produced semi-finished plastic articles. Examples of sheet material are single-layer films, tubular film webs, whereby the hose pipe can be separated or can be let in tubular shape, hose pipe foils being putted together, and webs produced in two dimensionally constructions of fibres of limited or endless length. Foil webs can be layered or multi-layered. Examples of products made of sheet material (web product) are packaging of confectionery, diapers, agricultural films and carrier bags.

S7

In general, “plastic” is, in particular, thermoplastic and/or duroplastic.

A “product” means a product manufactured by a technical process. A “finished product” is a final article and a subset of the product, which is used by the end customer. The word “product” is also used for all precursors of the final product, in particular for plastic granules, sheet materials, rolls and/or the other semi-finished products.

Under “producing” a “product” or “production” is understood a transformation process which creates a “product” performed by work, which consists of natural or already worked raw-/starting materials (German: Ausgangsstoffe) using work equipment and/or energy.

A “communication protocol” is an agreement according to which a data exchange between two parties and/or devices is performed. A communication protocol can be defined as a set of rules that determinate the syntax, semantics and synchronization of the communication. Communication protocols can be implemented by hardware, software or a combination of both. At the lowest level a protocol defines the behaviour of the interconnected hardware. In particular, an industrial communication protocol can be used for automated information exchange between terminals such as machines, automatic machines, or containers, with each other or with a central control centre, and which uses the internet with the various access networks, such as the mobile network. A communication protocol is among other things in the case of a data exchange necessary needed within a system integration, so that individual or autonomous systems will be able to exchange information due to electronic information data.

Specifically, it has been thought in a “communication protocol”, in particular OPC-UA, in particular in accordance with IEC 62541 and/or DIN EN 62541 Part 8, MQTT, in particular according to ISO/IEC 20922, and/or AMQP, in particular according to ISO/IEC 19464.

A “machine” is a technical structure with moving components.

It has been shown that the information density of modern value creation chains in the plastic processing industry, especially in the sheet material sector, is steadily increasing. Starting materials, semi-finished products, products and end products comprise more and more evaluated properties with growing demands on the desired specifications. Production machines, machines for further-processing and related products processing and processes for further-processing are becoming more and more complex and enable an ever-increasing product variety. Equally, the complexity of the logistics with the associated processes as well as that of the management tasks is steadily increasing, so that, as a whole, a steadily more and more dense and more and more interconnected network of interdependent information has arisen.

Having in the near past, the possibilities of producing of sheet material to obtain specific properties desirable for the end user, which have been increases, the possible properties of the end products have also been extensively and final products have become more versatile. This is accompanied by the variety of information to be processed in the value creation chain of the fabric processing industry, especially in the field of web sheet materials, which has grown steadily.

The state of the art has so far provided that, in particular, the coordination of production, product features, logistics and management within the value creation chain of the plastic processing industry is mainly carried out manually, special in the field of sheet materials. The processing of the information involved and the decision to be taken within the process chain of producing a predominantly semi-finished product of plastic is made by persons that exchanges information with each other and pass it on.

By way of derogation, a synchronization of the flow of goods and information is assumed here.

It proposes to couple the value creation chain of plastic-based sheet material with information and communication technology, especially in the field of research and development, raw material, production of sheet materials, processing of sheet materials, production of end products, market events, logistics and management.

Specifically, among other things, it is proposed an intelligent networking of information also with help of a uniform communication protocol in the value creation chain of plastic-based sheet materials, which advantageously provides automation of processes, in particular an automation of production processes, logistics processes and management processes.

Through the here proposed management of data and information with the help of a standardized data element, in particular the representation, the settlement and the automation of processes is simplified in a particularly advantageous manner. Additionally, doing so, it can be achieved thereby advantageously that the generation of integrated evaluated additional information is greatly simplified. For example, based on the over-lapping value creation chain collected and exchanged information, the effort of each product or the amount of CO₂ can be determinate.

Doing so, among other things, it can be achieved advantageously a fast adaptability of production plants, whereby the individualization of products can be driven forward economically, and especially small series of individual customer requirements of customized product solutions can be achieved at attractive costs.

Together with the over-lapping value chain creation exchange of information under assistance of a uniform communication protocol it should be proposed here according to the method to create a determination about the data rights, so that it can be advantageously achieved that only authorized circles can read, write or delete information. In particular, it is specifically proposed, inter alia, that the one in the value creation chain, who provides information, can decide who should get access to this information.

In particular, it is proposed here that both, persons and data processing equipments, for example, that of a production plant, have access to information, so that data can be written, read and deleted by both, persons or data processing equipments.

For example, it is suggested to synchronize the flow of goods and information in the value creation chain of plastic-based sheet materials, in a stages-over-lapping manner, with the help of a data element, whereby information are provided in one stage of the value creation chain to the data element, and this information can also be accessed and used in a second stage of the value creation chain.

It is conceivable that information from one data element at each stage of the value creation chain can be accessed and used, provided that a corresponding authorization to retrieve and use the information is present.

It is concretely suggested that access to information in a data can also be made anonymous in a statistical evaluation, so far such legitimacy exists. So it is possible to evaluate a plurality of information statistically without to order one single information to a concrete flow of products.

Furthermore, here a digital roll protocol is proposed which comprises one or more data elements and which is clearly associated with a roll that is performed for the transport of sheet material as well as for the rolling up and for unwinding of sheet material.

The digital roll protocol is a kind of a digital leaflet which contains all the relevant and/or interesting information which are linked with the sheet material associated with the roll.

In particular, the digital roll protocol can be linked more clearly with the identification of the roll. Thus, it is specifically proposed here, among others, that the roll has an identification code, in particular a bar code, a QR code or a matrix code, or that the roll is equipped with an RFID chip.

For example, it is proposed that the identification code or the RFID chip can be read with a suitable electronic data detection device, which allows that the link can be performed, for example, clearly between the roll and the digital roll protocol, so that with existing authorization of the electronic data detection device a data element can be provided, retrieved and used.

According to the proposal made here, a data element associated to the digital roll protocol is provided on a location-independent memory.

In concrete terms, it is also conceivable that the data element associated with the digital roll protocol is present on a data memory that is implemented within the electronic data detection device or is networked with the electronic data detection device for data exchange.

In particular, it is suggested that the digital roll protocol contains information about the value creation chain of the sheet material that stand in relation with the sheet material on the roll. In particular, it is proposed that the information is related to the period from roll change and to the roll change, that means the period from the time point that the roll was rolled with sheet material and to the time point in which the roll was rolled with sheet material.

It also proposed to provide the corresponding times in a data element of the digital roll protocol.

It is also suggested that the information included on the digital roll protocol can be compressed on demand. Does a process property, that is to record on the digital roll protocol, not change, for example, it is enough to record this constant value only once on the digital roll protocol. However, if a value changes over time, so it is proposed to provide the information in one constant time interval in the digital roll protocol, wherein the time interval may vary for different values.

It is also suggested that several rolls can be assigned to an order over their identification of the roll over a data element, whereby the logistic, in the the scope of a specific customer order, can be advantageously simplified.

Advantageously, the overall result is that a synchronization of goods and digital information flow can be achieved. Thus, a unique assignment of the recorded information about the identification of the roll to the sheet material of the roll can be performed.

Achievable advantages of the present invention are an increased level of information exchange, that allows a process optimization of the value creation chain of plastic sheet material in the areas of raw materials, semi-finished products, processing of semi-finished products, logistics and management of the value creation chain. Doing so, for example, serial machines can be adjusted advantageously on the individual goods characteristics. In particular, variations in the process parameters at one stage of the value creation chain can be considered advantageously in subsequent stages. In other words, the data element provides on the digital roll protocol relevant information for further use so that, for example, the processing machine can be set already automatically adjusted to the required parameters for the next processing steps.

In addition, an optimized production planning and control of all parts can lead to one further processing of B-ware in another not so demanding end product to the advantage that the scrap of goods can be advantageously reduced.

Furthermore, process optimization over an element in the value creation chain further allows advantageously that the energy consumption up to the final product can be reduced.

Overall, the invention can significantly contribute to the fact that the efficiency within the value creation chain around the semi-finished product can be improved significantly.

The data element preferably has a substance property, in particular a substance property of a product, in particular a starting material and/or semi-finished product and/or a final product.

Conceptually, the following is explained:

A “substance property” is a substance-specific, characteristic size that characterizes a substance. Each substance is characterized by a unique combination of material properties by which it can be identified. Substances used are, for example, a plastic granules, auxiliaries and additives.

A “starting material” is used as starting material for further processing steps in the production. An example of a starting material for the production of sheet material is granulated plastic and an auxiliary and/or an additive material.

In particular, a starting material is a polymeric raw material (polyolefins, polycondensates, PP, PE, PA, PET, PBT, PLA). A starting material may be defined in particular by MFI (melt flow index), intrinsic viscosity and/or a melting temperature. A starting material may comprise an additive, in particular a dyer, an antiblock, an antifog, a slip additive, a filler (for example CaCo3) and/or a adhesion promoter.

A “semi-finished product” is a product in the production process and also a product, which is so long defined as semi-finished product until the final product is completed or until it has been further processed to a final product.

Semi-finished products are in particular blown films, flat films, plastic plates, plastic panels and nonwoven made of synthetic fibers, in particular spunbond nonwoven or meltblown nonwoven or composite nonwoven. All semi-finished products mentioned here are sheet materials or are made of these, so that all here referred semi-finished products in the course of this application are to be understood as web goods and the term sheet material is used separately for each of the mentioned semi-finished products.

By definition, a semi-finished product remains a semi-finished product until it is a finished product, which is packaged to the end client (consumer) on the way. In particular, semi-finished product are:
nonwoven, in particular nonwoven which are still processed into a diaper (German: Windel),
films, in particular films that are still being printed,
printed films, in particular printed films, which are still reshaped in a packaging product.

For example, it is proposed here that a material property is provided in a data element, whereby also a material property can be included in the synchronization of the flow of goods and information of the value creation chain for sheet material, in particular a material property of a product, in particular of a starting material and/or semi-finished product and/or a final product.

This also allows properties of substances to be available, for example, those that were determined inline in a production device or offline in a laboratory, in the digital roll protocol or generally with a data element.

Advantageously, it can thus be achieved that also material properties are synchronized with the sheet material, in particular material characteristics determined in a laboratory, and to provide them for optimization in the value creation chain of the sheet material.

In particular, a substance property can be linked to an identification of a roll.

Optionally, the data element has a product characteristic, in particular a performance of a starting material and/or semi-finished product and/or a final product.

Conceptually, the following is explained:

A “product characteristic” is a physical or chemical property of a product, in particular a semi-finished product or a final product. Examples of product properties of sheet material are density, geometry, transparency and much more. The sum of several product properties can also be referred to as the “quality” of a product.

Under a “product property” of a sheet material/product, in particular a film or a nonwoven, is to understand, for example, a strength, an elongation, a surface weight, an air permeability, a barrier property, an optical property of a film, a surface energy or stickiness. Furthermore, a product can also have inspection data, which provide information on whether a sheet material is error-free or if a particular defined position is not error-free.

Similarly, is this to apply to a property of a product, wherein in one of the last process steps a semi-finished product converts into a final product. Also, it is possible that the descriptive properties of the semi-finished product are not directly apparent properties but are described in a processing machine for further processing, in particular a so-called running behaviour. Under a running behaviour is understood how a roll can be unwound and how exactly this is running, without wrinkles, without kinks through the processing machine for further processing. A feedback of this running behaviour and an analysis of a data element can identify settings for process parameters, which optimize the running behaviour.

It is optionally conceivable to take a product property into a data element, in particular a product property of a starting material and/or a semi-finished product and/or a final product, so that it can be advantageously achieved that a product characteristic can be synchronized with the sheet material and be used for process optimization in the value chain.

It is further proposed that the product characteristic be either inline with a suitable sensor or offline in a laboratory on the basis of a material sample.

In particular, it can be achieved so advantageously that a product property can be recorded in the digital roll protocol of the sheet material.

Preferably, the data element has a process property, in particular a production process property and/or a logistics process property and/or a management process property.

Conceptually, the following is explained:

A “process property” is a characteristic of a process, in particular a production process, a logistics process or a management process.

A process property is, for example, a temperature, a pressure, a rotation speed, a speed or their respective deviation over time or calculated further process parameters.

The characteristics of a machine used in the “production process” are “production processes”. Examples of production processes are production and further processing of product.

Properties of a “logistics process” also fall into the category of process properties, are referred to as “logistics process characteristics” and are, for example, distribution channels, storage locations, warehousing and modes of transport.

A “logistics process property” is in particular also an information about a storage condition, in particular a storage time, a storage temperature and/or a humidity, a transport condition, in particular a temperature and/or a relative humidity, packaging information, in particular information about how many rolls are on the pallet and/or how a product or a semi-finished product is labelled.

Furthermore, the characteristics of a “management process” fall under the properties and are referred to as “management process properties.” Examples for a management process are the carrying out of a data analysis, a production of expert knowledge, a production planning, a production control and management of research and development activities.

A data analysis in the context of a management process can follow different aspects:
securing a desired process property (set-actual comparison), statistical process control,
return of a data element to the production plant, which is used in particular to optimize the process settings due to machine learning,
generating expert knowledge through big data analysis and derivation of over-lapping process-chain and/or over-lapping value chain correlations.

From these results, research and development processes are initiated and/or supported.

In particular, it is conceivable, among other things, that a management process has a production planning, wherein the actual data from at least one process can be used, so that production planning is always possible based on the real conditions in the process chain. The aim of a production planning is to optimize production processes.

This is especially important when dynamic changes occur, for example with regard to delivery bottlenecks in the raw materials or in a similar way important in connection with call orders or just-in-time deliveries.

Thus, it is concretely suggested here that a process property, in particular a product process property and/or a logistics process property and/or a management process property is taken with a data element in the synchronization of goods and flow of information, for example by means of the digital roll protocol of the sheet material.

With the proposed here, among other things proposed, inclusion of a logistics process characteristic in the over-lapping value creation chain data exchange, it can be advantageously achieved that a starting material, a semi-finished product, a product or an end product can be tracked down through the value creation chain, which also helps to find it advantageously easier.

By providing a production process property it is concrete among other things conceivable that the maintenance of a production machine or a processing machine for a further processing can be automated and planned accordingly at an early stage, so that, overall, the process chain within the value creation chain can also be optimized.

It is also conceivable that a roll of sheet material in a further processing process is separated in pieces and this separation is provided in a production process characteristic.

In the case of a piece separation of a roll of sheet material, concretely, inter alia, it is proposed that each piece is equipped with a separate divergent identification. In addition, it is specifically proposed for this case, inter alia, to include an inheritance process of data elements so that a data element can be transferred from a parent roll automatically to a fragmented children's roll. Likewise it is proposed to provide both, at the digital roll protocol in the parent role and at the digital roll protocol in the children's role protocol, a parent-child relationship in a process property.

Furthermore, it is proposed here, to provide in a logistics process property an information on which processing machine for further processing should further process according to the production process planning. In this way it can be advantageously achieved that the assignment of a sheet material can be simplified within the logistics process.

Thus, overall, it can be advantageously achieved that a process property in a different stage of the value creation chain can be used, especially for process optimization.

Within the logistic associated in relation with the production of a final product, there must be provided in the process chain always information about the location of a semi-finished product and/or an amount of a finished product and/or a required raw material or semi-finished product.

The boundary conditions for such a production planning process in which the logistic procedure are integrated in the planning, are undoubtedly extensive and growing with an increasing number of further processing steps steadily. Here, in concrete terms, is proposed, inter alia, that the boundary conditions of the flow of goods are integrated into the integration planning. This is advantageously made possible here by the fact that the synchronization of the flows of goods and services required for such an over-lapping logistics planning needed information can provide and/or deposit in relevant data elements.

Specifically, it is proposed here, to deposit the necessary boundary conditions during the production planning for the planning and the from the coordination of the logistic process into the corresponding resulting data elements, so that they can be used for planning optimization. In particular, it is conceivable that the planning process optimizes the production planning, whereby planning process begins at the desired completion date of the end product and, from there, as well as from the respective available transport capacities, storage capacities, processing machines for a further processing, from production machines, from starting materials and the respective variable costs are take into account.

In particular, this concerns, for example, first the amount of stock available in the warehouse standing raw materials and the corresponding needs, in particular, specified in quantity and time window, for the planned production and, according to availability, a preferably adapted production.

Typically, the semi-finished product produced is temporally stored before further processing. This requires transport from a production machine to a warehouse.

The transport can take place as a single roll or as a bundle of rolls on a pallet. In any case, an information to the transporter for transport from the machine is required. For the transport from the machine to a warehouse and/or out of a warehouse to a transport company requires information again. This chain of thinking can also be transferred to other logistics processes, which can be optimized equally, advantageously with the knowledge of the relevant information about the production process.

Another example is related to the further processing of the semi-finished products, in which in the process chain again information, regarding the retrieval from the warehouse and the availability of the machine for further processing, are needed. It can be also necessary, that the information of several semi-finished products must be considered. For example, if within a further processing step two roles of different semi-finished products are laminated to a web.

Furthermore, it is common practice that often in the production of rolls so-called benefit cuts are made, so that a great mother roll is not produced, that is later fed to the further processing, but rolls are produced, which comprise smaller widths than the extruded width.

Specifically, among others, the proposed synchronization of goods and information flows makes it advantageously possible, that a logistics-overlapping production planning can be performed, so that on the one hand, planning reliability can be increased and on the other hand the process costs can be reduced by using, inter alia, synergistic effects and cost models.

Preferably, the data element has a market property.

Conceptually, the following is explained:

A “market property” is a property of the market, and a “market” is the place of meeting of supply and demand from and to a product. In the value creation chain of the sheet material it exists a multiplicity of different markets for the different products, in particular, this market is global. Examples for market characteristics include demand, supply and price.

In the case of a “market model”, a consumer behaviour model should be considered. In particular, it can be described, what is bought by whom and/or which consumer determines the product selection and/or how marketing and how advertising have influence to the buying decision of the consumer.

A “market characteristic” of a product is understood to mean a property which in the narrower sense as seen from the point of view of the consumer are felt, experienced, visible product properties

Specifically, it is suggested, inter alia, that a market property, flows directly back to the end-product manufacturer, if only readable from consumer behaviour. It is also concretely conceivable, among other things, that market properties can be transformed into data due surveys so that felt, experienced product properties are available as data and can be evaluated.

Advantageously, doing so, it can be achieved that, for the value creation chain overlapping data analysis and creation of a model, also characteristics of the market can be included, so that, for example, the market requirements or the behaviour of consumers or buyers can be analyzed. Market properties can advantageously also be evaluated statistically.

Optionally, the exchange of a data element takes place across locations, in particular the exchange of one data element is worldwide possible.

Conceptually, the following is explained:

Under “across-location” is understood to mean that the exchange of a data element is not bound to one place, but is possible beyond the boundaries of a single place.

For example, it is proposed that the data element is been stored on a location-independent data memory, which is networked so that on it, across locations, in a particular preferably manner can be accessed worldwide.

Advantageously, it can be achieved that the synchronization of goods and information flow can also be guaranteed across locations, in particular worldwide, wherein a data store does, in general, not need to be transported with the sheet material or the flow of goods. Thus, it can also be advantageously achieved that the logistic of the flow of goods and information flow can be simplified.

Preferably, the exchange of one data element is performed across party lines, in particular the exchange of one data element takes place across companies.

Conceptually, the following is explained:

Under “across party lines” is meant that the exchange of one data element is not bound to one party, but it is possible beyond the boundaries of a single party. A “party” is a group of like-minded people. Also is to understand that a production unit and/or an economic unit and/or a location of a company and/or a company are a party.

Under “across-company” is understood that the exchange of a data element is not bound to a company, but beyond the boundaries of a single company is possible. A “company” is an economical independent organizational unit.

Here it is specifically suggested among others that the synchronization of flow of goods and flow of information can occur beyond a company boundary.

Advantageously, it can be achieved that information of a complete value creation chain can also be used if more than one company is involved in the value creation chain of a product.

Preferably, the exchange of a data element is performed with the help of a standardized software interface.

Conceptually, the following is explained:

A “software interface” is the part of an electronic system which serves for communication between different units.

In this case, a data element to be exchanged is transferred via a software interface and a there from resulting communication protocol.

For example, a data element is transferred from a production machine by means of a communication protocol, in particular to a location-independent data memory. Specifically, a communication protocol could be, in particular a OPC-UA, in particular according to IEC 62541 and/or DIN EN 62541 Part 8, a MQTT, in particular according to ISO/IEC 20922, and/or AMQP, in particular according to ISO/IEC 19464. In this case, transmitter and receiver are in the same network, and authentication is given systematically.

In all other cases, a data element is provided with an identifier and is transferred via a software interface and an associated communication protocol. In general, a software interface consists of:
a suitable input and/or output device, in particular an electronic data detection device,
an authentication required to transfer the data or to request the data,
where appropriate, a way to encrypt the data,
and a communication protocol which enables the secure transmission of data and gives feedback about the transmission quality.

Advantageously, it can be achieved that the provision, retrieval and use of information can be simplified and improved from one or more data elements by a standardized software interface to the information.

Optionally, both the first stage and the second stage can read and/or write the data element.

Specifically, with appropriate authorization of the parties involved it is conceivable that an information can be provided, accessed and used from a data element across stages in the value creation chain for sheet material.

Advantageously, it can be achieved that the synchronization of exchange of goods and information can be carried out and used also across stages in a value creation chain.

Preferably, the data element is used by the second stage for further processing of that product on the basis of which production at the first stage generates the data element and provides in the data memory, wherein the second stage is chronologically after the first stage.

Advantageously, thus it can be achieved that a data element provided during the production of a semi-finished product or a product can be used also for the process optimization of the further processing.

Preferably, the order of stages is not chronological, wherein the first stage and the second stage can be, each, a different and any and not necessarily adjacent stage in the value creation chain.

Here it is proposed that a data element can be used in case of any authorization by a user or a data processing device in value creation chain overlapping manner. It is also possible, for example, that the supplier of a starting material has access to a market characteristic, that can be provided within a chronological consideration only after the delivery of the starting material. In particular, it is also conceivable that a supplier of a starting material or another participant in the value creation chain can have connection to a digital roll protocol through an appropriate access and can view, read and use the information stored there.

Advantageously, thus it can be achieved that the overlapping value creation chain integration of the information use can be improved.

Optionally, the product, in particular the final product, is provided with an individual product identifier and comprises this below.

Conceptually, the following is explained:

An “identifier” is a characteristic linked to a specific identity for the purpose of unambiguously identification of the object bearing the marking. A “product identifier” is the identifier of a product. A “machine identifier” is the identifier of a machine. A “logistics identifier” is an identifier of a logistics service provider, a warehouse, a transport vehicle or similar. A “management identifier” is the identification of a management employee, a management department, an automatic data evaluation routine or something similar.

An “identification”, also referred to as an “identifier” (ID), can comprise individual features. Thus, an identifier can contain chronological data, individual ID of the manufacturer/producer, piece ID and individual order ID of the end user. This information is both optical and machine-readable according to the state of the art. Additional informations are individually customizable to the end user. Other features that are not directly contained in an identifier can be accessed individually via the data memory and/or the overlapping value chain management system, local or global, by allowing the access according to a manufacturer-specific method, in particular by a proprietary method. The identifier then points like a programming pointer to a record data in the memory.

It is concretely proposed, to fill a data element in addition to the information, in particular next to a property, with the specific identifier of the production machine, of the logistics or equivalent, so that an association between information and identifier within a data element is provided. This can then be used for secondary process steps to securely identify the source of information.

Specifically, it is proposed here that a final product is provided with an individual product identification, which can be comparably used to the possibilities of identification of a roll of a sheet material. So, in concrete terms, among other things that an information is linked in a data element via an identifier of the final product and is provided, read or used via this link.

Advantageously, doing so, it can be achieved that a synchronization of the flow of goods and information until to the end product is possible.

In addition, it is advantageously achievable, that an information from a data element with existing authorization can be provided, read out and used, via the linking to an end product identifier.

Preferably, a production machine for plastic sheet material is provided with an individual production machine identifier and has this below.

Conceptually, the following is explained:

A “production machine” is a machine for producing a plastic sheet material. Starting material of the production machine is a granulated plastic, optionally an adjuvant and optionally an additive.

A “production machine identifier” is the identifier of a production machine.

It is proposed here that a production machine is provided with a production machine identifier.

Advantageously, doing so, it can be achieved that all data elements of all semi-finished products, products or end products can be linked via the production machine identifier, which have the production machine identifier in a data element.

Also, doing so, it can be achieved that the production machine for a semi-finished, a product or a final product, and with participation in the production process, can be identified, provided that a corresponding data element of the semi-finished product, product or final product, in the case that a correspondent data element of the semi-finished product, product or final product, comprises a production machine identifier.

Preference is given to a machine for a further processing for plastic sheet material with an individual further-processing machine identifier and has these below.

Conceptually, the following is explained:

A “further-processing machine” is a machine for further processing of sheet material which has plastic or predominantly consists of plastic.

A “further-processing machine identifier” is the identifier of a further-processing machine.

It is understood that the advantages, as for the production machine identifier of the production machine described above, can also be applied on a further-processing machine with a further-processing machine identifier.

Also, doing so, a link between of the respective plant component directly to the sources of information is reached. So it is possible, for example, locally (for example, directly before the plant component itself) to display the following information, for example, to a display screen with a user interface: current process parameters and/or courses of process parameters and/or control settings and/or relevant spare parts for the production machine or the further-processing machine and/or a communication options of the provider and/or a supplier of raw materials (telephone number, automatically drafted e-mail for orders or the like) and/or commercial data (raw materials still in stock, already made reorders and the like) and/or a communication possibility of a customer.

Optionally, a transport vehicle for transporting the product is equipped with an individual provided transport vehicle identifier and has this below.

Conceptually, the following is explained:

A “transport vehicle” is a vehicle that is suitable for transporting the product.

A “transport vehicle identifier” is the identifier of a transport vehicle.

It is thus suggested that a transport vehicle is provided with an individual transport vehicle identifier. So it is conceivable, among other things, that an information is linked in a data element via an identifier of the transport vehicle and can be provided, read or used via this link.

Advantageously, doing so, it can be achieved that a synchronization of the flow of goods and information can also be made possible within the logistics processes.

In addition, it is advantageously achievable that an information from a data element, in case of existing authorization about linking to a transport vehicle, can be provided, be read out and used.

The data element is preferably connected via a data detection device to the product and/or the production machine and/or the further-processing machine and/or displayed to the transport vehicle and/or detected and/or linked and/or provided and/or used.

Conceptually, the following is explained:

A data element is displayed, recorded and linked using mobile end devices. On displaying data is also understood as reading data. Such a mobile end device is referred to as a “data detection device”.

A “data detection device” may be a mobile data detection device or be connected stationary with a machine. It is an electronic unit that deals in organized manner with a data element and/or a plurality of data elements (amount of data) while pursuing the goal of gaining information about this amount of data or to change this amount of data. Doing so, the data are recorded in data records, and processed according to a given procedure by man or machine and are outputted as a result.

Advantageously, it can be achieved that a data element can be simply provided, read or be used with a mobile or stationary electronic data detection device.

Preferably, the product identifier and/or the production machine identifier and/or the further-processing machine identifier and/or the transport vehicle identifier are read opto-electronically and/or electromagnetically.

Conceptually, the following is explained:

Under “optoelectronic” is meant all processes that allow involving the conversion of electronically generated data and energy in light emissions and vice versa.

Advantageously, it can be achieved that an identification of a roll or a Identifier can be, in particular a bar code, a QR code or a matrix code, and be can be read opto-electronically in a simple manner, for example with a mobile electronic data detection device, whereby when reading the codes a link to the data element is made, if a correspondent legitimating right exists.

It can also be advantageously achieved that a data detection device can read electromagnetically the RFID chip used to mark ware, a product, a production machine, a further-processing machine or a transport vehicle.

Optionally, the data carrier is a location-independent data memory that is crossing places and/or crossing parties.

Advantageously, it can thus be achieved that an information of a data element can be provided, read out or used independent of the location.

The plastic sheet material is preferably a spunbond nonwoven (German: Vlies).

Conceptually, the following is explained:

A “nonwoven” is in particular a structure made of fibers of limited length, continuous fibers or cut yarns of any kind and of any origin, which in any way are joined together to a fibrous layer or a fibrous web and in some way have been joined together, in particular a spunbond nonwoven or a meltblown nonwoven or a composite nonwoven.

With the “spunbond nonwoven”, the filaments or fibres are spun like in the conventional spinning process from melt or solution. Therefore, a polymer granules is melted and fed to a spinneret. The exiting threads (filaments) become immediately aerodynamically or mechanically pulled and thereby stretched. The filaments are deposited in circular arcs.

It is understood that the advantages of the first aspect of the invention, as above described, from a sheet material can also extend to spunbond nonwoven.

In particular, the plastic sheet material is a meltblown nonwoven.

Conceptually, the following is explained:

With the “meltblown nonwoven” the filaments or fibres are spun like the conventional spinning process from melt or solution. Thus, a polymer granules is melted and fed to a spinneret. The exiting threads (filaments) are, still liquid, via a hot air stream torn. This creates fine individual fibers.

It is understood that the advantages of the first aspect of the invention, as above described, from a sheet material also extend to meltblown nonwoven.

Optionally, the plastic sheet material is a composite nonwoven.

Conceptually, the following is explained:

The “composite nonwoven” is a nonwoven which consists of a component consists of spunbond nonwoven and a component of meltblown nonwoven.

It is understood that the advantages of the first aspect of the invention, as above described, extend from a sheet material also to composite nonwoven.

The plastic sheet material is preferably a blown film.

Conceptually, the following is explained:

A “blown film” is a plastic film web which has been made by blown film method.

It is understood that the advantages of the first aspect of the invention, as above described, from a sheet material extend also to the blown film.

The plastic sheet material is preferably a flat film.

Conceptually, the following is explained:

A “flat film” is a film web made of plastic, which has been produced in the cast film process.

It is understood that the advantages of the first aspect of the invention, as above described, from a sheet material extend also to a flat film.

Optionally, the plastic sheet material is a plastic plate.

Conceptually, the following is explained:

A “plastic plate” is a plastic web sheet which is made in a plastic casting process.

It is understood that the advantages of the first aspect of the invention, as above described, from a sheet material extend to a plastic plate.

Preferably, the plastic sheet material is a plastic panel.

Conceptually, the following is explained:

A “plastic panel” is a plastic board that has been produced in a plastic casting process. Plastic panels can be made from sheet material and are also taken here under the expression sheet material.

It is understood that the advantages of the first aspect of the invention, as above described, from a sheet material extend also to a plastic panel.

The overlapping value creation chain synchronization of goods and information flows has one or more central and/or decentralized data memories. The reading in and reading out of the information flows occur via a data detection device. The data detection device which can be a mobile portable or permanently installed device which can read in and/or generate an identifier, in particular by means of an RFID chip, a QR code, a bar code, a lines code and the like. Doing so, the device can perform an authentication and thus allow individual context-sensitive read and/or write permissions. Participants from the value creation chain are either acting persons and/or machinery and/or equipment, such as raw material and raw material producers, reactors for the production of raw materials of the extrusion, plastics processing plants, plastics processing plant operators, semi-finished products, more precisely rolls of sheet material, further-processing machines (shrink packaging plant, testing device, shrink tunnel, shrink hood plant, coating plant, laminating plant (German: Kaschieranlage), laminating plant (German: Lamminieranlage), film plant, rewinding machine consisting of e.g. unwinder and/or rewinder, metallizer, press machine, thermoforming machine (German: Tiefziehanlage), bagging machine (German: Absackanlage), hood stretcher, self-winding stretch machine, diaper machine, etc., operators of further processing machines, laboratory for determination of offline parameters, employees of a laboratory for the determination of offline characteristics and/or properties, Inspection detection systems for the determination of inline and/or offline characteristic values and/or properties, warehouse, employees in the warehouse, transport, transport employees within a company or between various establishments of the same or at least two different companies, production scheduler and management to control and optimize individual processes or the entire process chains. It is envisaged that the data from the life cycle of a ware in the value creation chain can be visualized at any time in a context-sensitive way and is evaluable. The amount of visible and/or retrievable information depends from the authorization of the individual participant of the process chain and is controlled from the data detection according to an adjustable authorization profile, which decides on the appropriate authentication.

According to the invention, it is for example in the delivery of new raw materials, for example plastic granules, provided to read in related information, such the nature of the raw material, the date and place of production, the reactor, the in the production used filter, condition of the granulator, the batch/lot number, the quality of the granules themselves (specks), the properties of the starting materials (molecular weight distribution, MFI, viscosity), a by the manufacturer recommended processing date and so on. The reading of the information(s) can occur after the delivery of the goods in the form of sacks or octabins with an in the electronic data detection device integrated scanner directly on the packaged raw material itself or by providing the information in the memory by the raw material manufacturer, so that at the beginning of production is provided only a referencing of the stored information about the raw material currently being processed. So it can be planned based on the quality of the goods in the warehouse the production in terms of achievable quality of the semi-finished product. In a similar way, the information of goods that are intended for delivery in silos can be read into the memory.

The plant for producing a wound web, that is a roll, is an extrusion plant. The extrusion plant can request for product adjustment and/or product conversion information from the memory. The trigger to request this information can either be performed by an operator of the plant, an employee in the work preparation or automatically. The information contains information on the recipe (exact designation of type and quantity of raw materials used, etc.) as well as machine settings. The reading in such information over an interface manual input by an operator has the advantage that errors and so that rejects in production by incorrectly set parameters are reduced. Just like the system reads information from a memory about a suitable detection device, it writes this information into the memory, which is relevant for further processing of one or more semi-finished product(s). Information may include, inter alia: date of manufacture, manufacturing time, i.e. start time and end time of the roll, place of manufacture, the used machine (type, manufacturer, machine number, maintenance condition), recipe (exact name of type and amount of raw materials used), environmental conditions during production (air humidity, temperature and air pressure), machine setting values, process parameters and inline recorded quality parameters of the produced semi-finished product (for example specks).

The product of the extrusion process is a so-called semi-finished product. Each roller cut can be a semi-finished product either of a roll or several semi-finished products are produced, i.e. several roles in the case of one or more so-called benefit cuts. In any case, according to the invention of each semi-finished product, i.e. each roll, should be provided with at least one identifier. An identifier is preferred applied both at the beginning and on the end of the roll, on the web. The application of the identifier takes place most preferably redundant on the first and last meters of the web. In a special preferred embodiment, an identifier is applied both longitudinal and transverse to the machine direction, two or more times. Doing so, it can be advantageously prevented that in case of damage or loss of an identifier, a referencing of a role is no longer possible to an associated data element and thus indirectly to an information.

The invention further provides that also a referencing to an offline in one laboratory determined quality parameters, in particular a property, is possible. Therefore, for example, it is intended to take from a manufactured roll to the extrusion plant one or more samples (i.e., e.g., a short section or cutting of the web), to provide each of these samples with an identifier and to carry out the desired tests on these, in a laboratory. Via each applied identifier a unique assignment of a role to a sample is possible because for the one or more performed tests, also in the laboratory, a data detection device is provided. Doing so, it is advantageously possible an unambiguous assignment from manufactured goods to the offline determined quality. The unambiguous storage and assignment of information concerning the production, in particular the achieved quality of a roll, are on the one hand an important building block in the documentation of the quality and the other hand a starting point for the further-processing of the semi-finished products. On the basis of this information, a further-processing machine can be set advantageously, because it has like the extrusion plant a data detection device, which allows the exchange of information by means of a data element.

In the production and further-processing of semi-finished products, logistics takes a central role. It is for the participants of these parts of the process chain, depending on their perspective, always advantageous to know, when, how many rolls where produced, stored, be transported or delivered. Therefore, it is intended that also an area, such as warehouse and transport/logitics, exchange information via a data detection device by means of a data element. It is intended, for example, in the spirit of the invention, that a production machine reports the completetation of a roll via a suitable data detection device, and depending on the equipment of an intermediate warehouse on the extrusion machine a transport of the produced roll (packed or unpacked) into a warehouse is performed. The transport request for the removal of semi-finished products away from the extrusion plant into an intermediate warehouse can either be done by a machine operator person or automatically. In any case, the requirement of transport, the documentation of transport and storage of the rolls are performed via an exchange of information via appropriate data detection devices. For example, a forklift driver may capture or document the receiving of a roll and the storage into a specific storage location with an electronic data detection device by means of the built-in scanner.

According to a second aspect of the invention, the object is solved by a method for classifying a process quality in the multi-stage value creation chain of a plastic sheet material, for example a blown film web, a flat film web or a nonwoven web, for producing a final product, for example a packaging film, an agricultural film, a thermoforming film, a plastic plate or a diaper wherein classifying is based on information and/or properties about the stages and/or a raw material and/or a semi-finished product and/or the end product takes place, in particular by means of a method according to a first aspect of the Invention, in such a way that for at least one information or property, preferably for several, particularly preferably for all, a good area and/or a bad area can be defined, wherein information and/or properties along the stages are determined—preferably authenticated by means of sign or an identifier-as a data element locally or, above all, are removed in a data record transmitted and stored via a communication protocol, either as the pure Information and/or property, or only as included in the good area or bad area, or both together, or different depending on the stage, wherein using the data record the classifying of a process of the stage, a process creation chain along multiple stages, the final product and/or a manufacturer is performed, preferably with at least one class from the classes “in all stages in the good area”, “in one certain number of classes in the good area”, “in certain particularly important classes in the good area”.

In this way, a certification for the products can be made possible, for process steps and/or for the manufacturers at the different stages.

It is provided in the sense of the invention that information from the entire production chain, beginning from the raw materials to the final product at the consumer can be assigned as information in at least one data element in one or more value creation stages of the value creation chain. In this way, among other things, a synchronization of goods and information flows is made possible. It is expressly provided that an information is contextual; i.e. is available to the needs of the respective block of the process chain. By the linking of an information with an identifier in a data element this contextual reference can be produced.

Furthermore, it is specifically intended, inter alia, that information that relates to the production of the semi-finished product, in terms of a certificate or a guarantee certificate of downstream participants in the process chain and, possibly, also upstream participants, can be provided. More precisely, it is intended that information, which are specified by a participant in the process chain, and thus are to be followed by another participant in the process chain as a signature on a data element, are filed. This data element can be used as the basis for a certificate, which can be provided to one or more participants in the process chain. It is crucial that information are added to the data element additively, via a corresponding interface, between two value creation stages, wherein a life record is created.

In particular, it is conceivable, among other things, that the raw material supplier, which supplies the starting materials, issues a guarantee certificate, which guarantees the characteristics of a source material.

An information about a starting material relates, for example, to its raw material class.

Doing so, among other things, difference is made between polymers, fillers, adhesion promoters, additives (anti-melt fracture, anti-block). It is expressly intended that this information does not only concern to the nature of the raw material itself, but also to the date of manufacture and the place of manufacture, the reactor, the batch/lot number, the quality of the starting materials (specks), the properties of the starting materials (molecular weight distribution, MFI, viscosity), a by the manufacturer recommended processing date and comparable things.

Additional information added to a data element as information can relate the date of manufacture, the time of manufacture, i.e. start time and end time of the roll, the place of manufacture, the machine used (type, manufacturer, machine number, maintenance condition), recipe (exact description of type and quantity of used raw materials), environmental conditions in the production (humidity, temperature and air pressure), machine setting values, process parameters and quality parameters of the semi-finished products.

Information stored in a data element in accordance with the invention can be also information regarding transport and storage (ambient conditions, storage time) because these can often influence the further-processing. So it is known, for example, that the film can be stretched in process stable manner only after a certain period of time production, in a certain time window, in a second step in an MDO, otherwise, an impermissibly strong hole formation occurs more often as a result of the progressive recrystallization. On the other hand certain steps in the process chain require storage times, when processing laminated film composites, before these are cut into smaller units. Thus, the identifier allows to use this information in the production planning as well as in the process planning.

The collected information are collected cumulatively via the process chain.

For example, according to this aspect of the invention, it is possible here, that within one stage, a certificate for the properties obtained at each stage is issued automatically and can be made accessible to the downstream stages of the value creation chain.

Furthermore, it is possible that a certificate can be issued, which contains properties from several value creation stages of the value creation chain.

Doing so, advantageously, it can be made possible that the downstream stages in the value creation chain can be guaranteed by means of a certificate, which properties has a semi-finished product or a product or a final product. Furthermore, doing so, advantageously, it can be reached that defects in the product produced in the downstream stage in the value creation chain—which are the result of defective and incorrectly certified characteristics of an upstream value creation stage—are the result of the upstream stage, and can lead there also to damage compensation in the case of a guarantee certificate.

According to a third aspect of the invention, the object is solved by the use of data, which have been provided by means of a method according to the first aspect of the invention, for constructing a production machine or a further-processing machine or a plant which is used in the value creation chain of plastic sheet material, in particular a spunbond nonwoven, a meltblown nonwoven, a composite nonwoven, a blown film, a flat film, a plastic plate or a plastic panel, used to produce a final product.

Specifically, it is proposed here, inter alia, that the—via an overlapping value creation chain synchronization of the flow of goods and information provided—information should be used to obtain—via analysis of the information—new insights for the optimal design of a production machine or a further-processing machine or a plant, which is used for producing of a final product.

Furthermore, it is proposed here that the obtained insights can be advantageously used for the construction of such a machine.

Particularly advantageous results here that the information can also result from other stages of the value creation chain, from other locations and/or other companies, whereby the number of data can be increased and also knowledge from other areas or the experience of other companies or locations can be used.

It is understood that the benefits of a method for providing, retrieving and use of a data element—in the value creation chain of a plastic sheet material for producing a final product, by means of a communication protocol and a data carrier for the step-by step overlapping exchange of a plurality of different data elements for producing the final product within the value creation chain, wherein the data element is used in the value creation chain in stage overlapping manner, namely provided by a first stage by means of the communication protocol on the data carrier and retrieved from a second stage by means of the communication protocol from the data carrier and used on a machine of the second stage, and as above described—extend directly to the use of data, that are provided by means of a method according to the first aspect of the invention, for constructing a production machine or a further-processing machine or a plant, which is used in the value creation chain of plastic sheet material, in particular a spunbond nonwoven, a meltblown nonwoven, a composite nonwoven, a blown film, a flat foil, a plastic plate or a plastic panel, for producing a final product.

It should be expressly understood that the subject matter of the third aspect can be advantageously combined with the subject matter of the above aspects of the invention, namely cumulatively either individually or in any combination.

According to a fourth aspect of the invention, the object is solved by a method for improving a quality of a process, in particular a production process, a logistics process or a management process, within the value creation chain of plastic sheet material, in particular the value creation chain of a spunbonded nonwoven, a meltblown nonwoven, a composite nonwoven, a blown film, a flat film, a plastic plate or a plastic panel, for producing a final product, wherein a data element is retrieved and used by means of a communication protocol and a data carrier for stage overlapping stage exchange of a plurality of different data elements, wherein a quality of the process is described depending on an information of the data element, the data element is used for improving the quality the process and by improving the quality of the process, such that a desired property, in particular a material property, a product characteristic, a process characteristic or a market characteristic, is increased in its dimension and/or an undesirable characteristic, in particular a material property, a product characteristic, a process property or a market characteristic, is reduced in its dimension.

Conceptually, the following is explained:

The “quality” includes all objectively and subjectively perceptible properties of a process. In this context, a difference is made in particular between material properties, product properties, market properties and process properties, in particular characteristics of the production process, the logistics process or the management process. The dimension of a property is registered numerically in one “property value”, which can be varied and optimized in terms of set targets.

A quality may in particular be a product quality or a process quality.

There, a product quality can be defined both absolutely and relatively. A relative product quality results from the comparison of that of a nonwoven or from a film required product characteristic (set) and the achieved product characteristic (actual) in a deviation of the mean values (set/actual) and in deviation of the measured values (actual) among themselves. For example, as a product quality may required that a film should have a thickness of 20 μm+/−0.5 μm, which corresponds to the average of 19.8 μm to be achieved. At the same time it may be required that a deviation of all measurements (according to required measuring method) is +/−5%, i.e. all measuring points must be greater than 19.8 μm-5% or less 19.8 μm+5%.

Thus, an absolute product quality can be defined in that, for example, agreed specific strength values of a nonwoven fabric should be achieved. Under specific strength values are understood to mean that a measured strength value (nonwoven usually noted as N/5 cm) is based on the basis weight (g/m²). A nonwoven has a higher quality insofar higher specific strengths are possible.

A “process quality” is for example an OEE (over equipment efficiency), a first yield, a quality of a machine, especially a maintenance condition. Furthermore, under process quality it can be understood, for example, whether a preventive maintenance is carried out.

It has been shown that the information from the stages of the value creation chain enables a variety of new insights integrated into the value creation chain.

Thus, it is here specifically proposed, among other things, that the information is used from at least one data element for the optimization of a process, which is carried out at a place of the value creation process of sheet material.

Here it is also suggested that the quality of the process that is optimized is described as a function of at least one information of a data element.

Objective of the optimization of a process is, among other things, that a desired property is increased in its manifestation and/or an undesirable characteristic is reduced in its manifestation.

A conclusion on the change in the final properties of the end product from sheet materials as a result of the envisaged networking of the information exchange was before only possible to a limited extent.

However, it has been shown that the potentials of process optimization depending on at least one information, in particular from a different stage of value creation chain of sheet material, are extensive.

Thus, in particular, it is proposed in the optimization of a process, that is performed at one place in the value creation process of sheet material, to use also at least one information from one—from the process to be optimized deviating—stage of the value creation chain for describing the quality of the process.

Advantageously, it can be achieved that the quality of a process and in particular a property of a semi-finished product, of a product or a final product can be optimized. Thereby, it can be achieved that a semi-finished product, a product or an end product has better properties, and that the cost of production of sheet material or products made of sheet material can be reduced and that the environment can be is relieved.

Advantages of the third aspect of the invention are an increased level of information exchange, that enables a process optimization of the value creation chain of plastic sheet material in the areas of raw materials, semi-finished products, further processing of semi-finished products, logistics and management of the value creation chain. Thus, for example, serial working machines can be adapted to the individual characteristics of the goods. In particular, variations in the process parameters can be considered in one stage of the value creation chain in the other stages of the value creation chain.

In addition, an optimized production planning and control of all relevant parts can result in a further-processing of B-ware in another not so demanding end product, so that the scrap of goods can to be reduced.

A process optimization to a single element in the value creation chain also allows in addition that the energy requirement up to the end product can be reduced.

Overall, the invention can significantly contribute that the efficiency within the value creation chain around the semi-finished sheet product can be significantly improved.

Preferably, the quality of a production process is improved.

In concrete terms, it is proposed here, to continuously improve, in particular, business processes and production processes or development processes and the use of the required resources. Thereby, as a base should serve a process-oriented viewing of the entire process up to the end product.

Advantageously, it can be so achieved that the cost of a production process and/or the throughput times of a production process of sheet material can be reduced.

Furthermore, it can be advantageously achieved that the product properties, consisting of a production process, can be improved, in particular positive product properties can be improved and negative product properties can be reduced.

Optionally, the quality of a product further-processing is improved.

Advantageously, it can be achieved that a semi-finished product or a product made of sheet material can be processed faster and cheaper.

In addition, can be achieved so advantageously that the positive properties of a further-processed product from sheet material can be improved and the negative properties of a product made from sheet material can be reduced.

Preferably, the quality of a process chain is improved.

Conceptually, the following is explained:

A “process chain” is understood as the chronological sequence of several processes. In this case, a process chain is” is understood not just as a serial procedure of processes. It is also conceivable, inter alia, that a semi-finished product or a product between two processing steps is pieced and the subsequent operation step is performed parallel on a plurality of production machines or further-processing machines.

It is conceivable that a semi-finished product or a product is pieced before transport and is transported with several transport vehicles or with a transport vehicle piece for piece to its destination.

Furthermore, it is conceivable that a semi-finished product or a product after its further-processing or after its transport is joined together again. It is also conceivable that a semi-finished product or a product is only partially reassembled.

Among other things, it is proposed here to optimize the sequence of a process chain.

It is also conceivable, among other things, that the order of two processes within a process chain is changed.

Advantageously it can be achieved that the costs and product throughput times of a process chain can be reduced. In addition, it can be advantageously achieved that the properties of a product are improved.

Preferably, the quality of a process setting is improved.

Conceptually, the following is explained:

A “process setting” is understood as the setting of a process. An example of a process setting is, for example, the setting of the web speed with which a sheet material is produced or is further-processed.

Among other things, it is proposed here that a variable process variable should vary, in order to increase the quality of a process and/or of a semi-finished product and/or a product and/or end product.

Optionally, product quality is improved by changing a machine setting.

Conceptually, the following is explained:

Under a “machine setting” it is understood the setting of all setting variables of a machine. Examples of setting variables of a production machine for plastic sheet material are, for example, a cylinder wall temperature, an adjusted extrusion speed and an adjusted rotation speed of the extruder.

Thereby, advantageously, it can be achieved that by the variation of a setting variable, of a machine, in particular the variation of a setting variable of a production machine or of a further-finishing machine, the quality of a semi-finished product or of a product or a final product is improved.

Furthermore, the production costs can be advantageously lowered by a variation of a setting variable of machine.

Preferably, product quality is improved by changing a process setting.

Advantageously, it can be achieved that the quality of a product is improved by the variation a process setting so that the properties of a product can be optimized.

Preferably, the quality is improved by a selection of a starting material.

Thereby, advantageously, it can be achieved that by an optimized selection of the starting materials the cost of production can be reduced. Furthermore, advantageously, it be achieved that the properties of a semi-finished product, of a product or of an end product can be improved.

Optionally, the quality of the production process is improved by reducing energy consumption.

Thus, it is here specifically proposed, to analyze the energy consumption within the value creation chain for sheet material using information from the value creation chain and to reduce energy consumption, so that, for example, throughput speeds are increased, or the transport routes are reduced or more process parameters are optimized, so that the energy consumption can be reduced.

Thus, advantageously, it can be achieved that the energy consumption of the production can be reduced.

Preferably, the quality of the management process is improved by analyzing one or more data elements to generate expert knowledge.

Here, among other things, it is proposed to analyze the information from the value creation chain of sheet and to improve the quality of the management process due the received knowledge.

Advantageously, it can thus be achieved that the quality of the management processes can be improved.

Preferably, the quality of a production planning is improved.

Conceptually, the following is explained:

The term “production planning” refers in particular to the operative, temporal, quantitative and spatial planning, control, management and control of all operations that are necessary in the production of ware and goods. The basic conditions of the production planning are often planned in the work preparation. In the foreground of the production planning is the optimization of the entire production system, by which the effectiveness and efficiency of the entire production process shall be increases.

Thus, it is specifically proposed here, among other things, that the throughput times in the individual processing steps and in the logistics processes are optimized so that occurring dead times can be reduced.

Furthermore, it is suggested that the production planner selects the machine with the appropriate operating window so that the throughput times matches in optimal way to the selected machine.

Advantageously, it can be achieved that the production costs of a semi-finished product, a product or a final product can be reduced.

In addition, it can be achieved so advantageously that the amounts of material can be reduced, that can be stored at a location of a machine.

Optionally, the quality of a production control is improved.

Conceptually, the following is explained:

Under a “production control” is understood the direct control of all processes of a production. Thus, strictly speaking, the “production control”, is a subarea of the “production planning.” While here, however, under production planning a rather static process is understood, that should be completed in the time before the start of the production should, the “production control” is demarcated by its close temporal relation to production. The production planning designs a plan about the procedure to be followed, wherein the production control modifies this plan, if necessary with high dynamics, and can react to unforeseen events.

Thus, it is proposed here that, for example, in cases when interferences occur with the actually planned process flow in one stage of the value creation chain, the production control intervenes via a dynamic adaptation of the processes of the value creation chain, on the base of the information about the processes within the value creation chain, and thus improves the quality of the production control as a result of the situation of fault, so that the disruption situation can be remedied again as soon as possible and with the, as least as possible, monetary damage.

Advantageously, it can be achieved that the production processes in special situations can be moved back to the planned rhythm as quickly and cost-effectively as possible.

Preferably, the quality is improved by controlling research and development activities.

Conceptually, the following is explained:

Under a “control of research and development activities” is to understand a process, consisting of several steps, of planning, controlling and inspection of development and development activities, whereby the individual steps must be closely interlinked and constantly adapted to the changing circumstances. In particular, in one step gaps in knowledge and thus research and development needs are identified. In another step possible research and development measures are identified, evaluated and selected. In addition, a step involves the integration of won insights in all relevant processes, so that achieved innovations can be made usable.

Advantageously, thereby, it can be achieved that the costs of research and development activity can be reduced and the proportion of marketable innovations can be increased.

It can also be achieved that required technological innovations can be implemented so quickly and as cheaply as possible.

Preferably, the quality is improved by optimizing a distribution channel.

Conceptually, the following is explained:

Under “optimization” of an optimization it is understood the search for the best achievable result taking into account all given boundary conditions. In particular, the optimization should achieve that a desired property, in particular a material property, a product characteristic, a process characteristic, logistic characteristic, or a market property, is increased in its manifestation and/or an undesirable property, in particular a material property, a product characteristic, a process a logistical property or a market property is reduced in its manifestation.

A “distribution path” is the path of a semi-finished product and/or a product and/or a final product to its destination. This distribution path can be a direct path between starting point and destination point. However, a distribution path can be also a non-linear path between starting point and destination point. In particular, a distribution path may include multiple layover. Thus, it is for example conceivable that a semi-finished product and/or a product and/or a final product is brought to an overlay, stay there for a dead time, if necessary, at least partially, is reloaded to another transport vehicle and is further-transported from there. It is also concretely conceivable, inter alia, that a semi-finished product and/or a product and/or a final product is at least partially stored at a stopover.

The distribution channels can be optimized within the value creation chain of sheet material.

On the one hand, the distribution channels can be optimized so that individual distances are as short as possible.

As a variant it is suggested that in optimizing the tour planning of transport vehicles, the loading capacity of the transport vehicles are taken into account and that they are used in the best possible way.

As a further variant it is proposed here that in addition to the tour planning the availability of transport vehicles and compatible drivers are taken into account.

It is also proposed as a further variant, in particular, among others, that in the optimization of a distribution route the required time of the transport vehicle is taken into account.

As a further proposed variant, the optimization of the distribution channel is performed on the base of the logistics costs.

It is understood that the proposed variants in terms of their optimization criteria, both individually and in any combination with each other, can be cumulatively taken into account.

Advantageously, it can be achieved that the transport times and transport costs can be lowered overall.

Optionally, the quality is improved by selecting a storage location.

Conceptually, the following is explained:

A “storage location” is understood to mean the location of a warehouse.

Here it is suggested, among other things, that the geographical positions of the storage locations are in such a way determined and/or relocated within a distribution network of a value creation chain that the logistics costs can be minimized. Thereby, It is proposed to take into account that goods can be reloaded at the individual storage locations, that goods are stored at the individual storage locations, that goods can be reloaded to other vehicles at the individual storage locations and that, thereby, the configuration of vehicles with goods can be changed and be adjusted to other boundary conditions.

Advantageously, thereby, it can be achieved that the logistics costs can be reduced and the times needed for logistics can be reduced.

Preferably, the quality is improved by optimizing a storage.

Conceptually, the following is explained:

A “storage” means the storage of starting materials and/or of semi-finished products and/or products and/or end products.

Thus, it is suggested that the amount of goods to be stored is be optimized. Thereby, It has to be taken into account that storage costs on the one hand, on the other hand, however, that set-up times can also arise during the conversion of a production machine or a further processing machine.

Here, among other things, is suggested to determine the amount of goods to be stored based on the optimal total cost of storage, logistics and production the of the goods.

Advantageously, it can be achieved that the sum of the costs for the production, the logistics and storage of a starting material, a semi-finished product, a product or a final product can be reduced.

Preferably, the quality is improved by optimizing transport costs.

Conceptually, the following is explained:

Under “transport costs” is understood to mean the costs of transporting a semi-finished product and/or a product and/or a final product.

Here it is proposed to minimize the transport costs by optimizing the processes within the value creation chain of sheet material.

Advantageously, it can be achieved that the transport costs can be reduced.

Optionally, the quality is improved by optimizing a logistics process.

Specifically, it is proposed here, among other things, to use an information from the value creation chain for the optimization of a logistics process.

Thereby, advantageously, it can be achieved that the logistics costs can be lowered within the value creation chain of sheet material.

Preferably, the quality is improved by optimizing management costs.

Conceptually, the following is explained:

Under “management costs” is understood to mean the costs of the management process. The management costs are here, for example, the costs of production planning.

Among other things, inter alia, it is proposed to use information from the value creation chain of a sheet material for the optimization of a management process.

Advantageously, it can be achieved that the management costs within the value creation chain of sheet material can be lowered.

For example, it can be provided that the data exchange, across the overlapping stages of the value creation chain, is used to minimize the specific energy demand for production of a final product. For this, the data obtained at the upstream stage production of the semi-finished product are stored in a data element and provided to the downstream, second or each further process step for retrieving. For example, at the downstream process step the print of a semi-finished product can—by exchanging the production and manufacturing data on a repeated, energy-intensive pre-treatment or surface activation by a plasma or corona treatment—be omitted or minimized in its performance, when the information is provided to the downstream process step, which specific degree of activation the semi-finished product had been undergone during its production in the first production step.

Furthermore, it is conceivable that by providing the production data a repeated heating—of a produced semi-finished product, preferably a film or a nonwoven, before lamination of the semi-finished product to a finished product, for example a laminate—can be dispensed, or the preheating or heating can be carried out with reduced power.

In addition, it is conceivable to control that the total amount of energy consumed at one location or a sub-location so that the occurrence of peaks in energy consumption is avoided. This can be done by merging and evaluating information from several process chains regarding the energy requirement and the coordination of production processes, more precisely, the adaptation of production parameters. An optimization of the energy requirement may be done e.g. by that the output of individual processes is reduced taking into account the required delivery dates.

Thereby, advantageously, it can be achieved that the energy required for the production of semi-finished products and/or products across value creation chains can be lowered. For this purpose, among other things, advantageously, synergy effects are used between the individual stages of the value creation chain.

It is also concretely suggested, inter alia, that the crossing value creation chain exchange of data, in particular the synchronization of goods and information streams, is used to manage defects in a sheet material.

For example, it can be provided that the data transmission between upstream production steps for the production of the semi-finished product and downstream production steps for further-processing, final processing or finishing of the semi-finished product is used to increase the quality of the final product. Surface defects such as specks, streaks, gels, black spots, fisheye, surface tears, melt fracture, flow lines, hard pieces, insects are detected from an inspection system, in particular an inline surface inspection system, for example by means of camera technology, infrared, ultrasound, X-ray, and assigned as a data element to the produced semi-finished product. By retrieving the data element during the further-processing, final processing or finishing of the semi-finished product, such as wide-stretching frame, coating plants or roll cutter, then, the faulty spot or the faulty range of sheet material is removed from the sheet material manually, semi-automatically or fully automatically.

In a holistic integration, order data from an operational data detection system can also be used to determine the production volume of the semi-finished product to determine how high the rejects are. In other words, thus, the production volume of the semi-finished product can be increased according to the reject rate.

Advantageously, an optimization of the order control can be achieved in such a way, that the target amount of the defect-free produced semi-finished product in the knowledge of the defect parts in the semi-finished product is adjusted, so that the predetermined amount of perfect semi-finished product is achieved, as accurately as possible. So can the dissatisfaction on the part of customers and the cost of producing the semi-finished product can be reduced.

Advantageously, thus, it can be achieved that rejects within the value creation chain can be reduced. Furthermore, the handling of defects in the semi-finished product can be advantageously simplified. Thereby, in particular, it can be achieved advantageously that the work efficiency and thus indirectly the cost efficiency can be increased in the value creation chain, because unavoidable defects in the semi-finished product can be considered by automated way and must not be considered individually as before by human intervention.

It should be expressly understood that the subject matter of the fourth aspect can be advantageously combined with the subject matter of the above aspects of the invention, namely cumulatively either individually or in any combination.

According to a fifth aspect of the invention, the object is solved by a method for producing a plastic sheet material, in particular a spunbond nonwoven, a meltblown nonwoven, a composite nonwoven, a blown film, a flat foil, a plastic plate or a plastic panel, wherein an extruder for plasticizing a plastic is operated, wherein during production a method according to the first aspect of the invention and/or the second aspect of the invention and/or the third aspect the invention is carried out.

Conceptually, the following is explained:

An “extruder” is understood to mean a “screw plasticizing machine”, in particular under an extruder, all known embodiments of plasticizing machines are understood that use a screw for conveying, melting and homogenizing. Thus single-screw plasticizing machines as well as twin-screw plasticizing machines as well as, generally also, multi-screw plasticizing machines fall into the related art of screw plasticizing machines and thus under the terminology of an extruder.

It is understood that the benefits of a method for providing, retrieving and use of a data element in the value creation chain of a plastic sheet material for producing a final product, extends by means of a communication protocol and a data carrier for stage-crossing exchange of a plurality of different data elements to produce the final product within the value chain, and/or extends to the benefits of using data to construct a production machine or a further-processing machine and/or extends to the advantages of a method for improving a quality of a process, in particular a production process, a logistics process or a management process, within the value creation chain of plastic sheet material for producing a final product, wherein the data element—by means of the communication protocol and the data carrier for the stage-crossing of a plurality of different data elements—is retrievable and usable for the stage-crossing exchange, as described above, namely directly on a method for producing a web of plastic, in particular a spunbond nonwoven, a meltblown nonwoven, a composite nonwoven, a blown film, a flat film, a plastic plate or a plastic panel, wherein an extruder is operated to plasticize a plastic, wherein during production, a method according to the first aspect of Invention and/or the second aspect of the invention and/or the third aspect of Invention is carried out.

It should be expressly understood that the subject matter of the fifth aspect can be advantageously combined with the subject matter of the above aspects of the invention, namely cumulatively either individually or in any combination.

According to a sixth aspect of the invention, the object is solved by an electronic data detection device for the crossing-stage provision, retrieval and use of a data elements in the value creation chain of a plastic sheet material, in particular a spunbond nonwoven, a meltblown nonwoven, a composite nonwoven, a blown film, a flat film, a plastic plate or a plastic panel, for producing a final product, by means of a communication protocol for crossing-stage exchange of a plurality of different data elements for producing the final product within the value creation chain, wherein the data detection device has a programming for carrying out a method according to one of the preceding claims, wherein the data detection device is performed for writing a data element, for providing the data element and/or for reading a data element for retrieving the data element, namely in each case by means of the communication protocol.

In particular, the electronic data detection device should read out opto-electronically a line code, a QR code and a matrix code.

Here, inter alia, an electronic data detection device is proposed, which can read an identification code opto-electronically or an RFID chip electromagnetically.

Among other things, it is proposed here that when reading an identification code or an RFID chip a linking to a data carrier or over a network is made to a location-independent data memory, so that an information is made available in a data element via the link, wherein after making a linkage, an information in the data carrier and/or the location-independent data memory is provided, read or is made available.

Furthermore, it is proposed here that the identification code or the RFID chip can be read with a correspondingly suitable electronic data detection device, thereby is made possible that the link between the roll and the digital roll protocol, for example, can be executed clearly, so that in the case of existing authorization of the electronic data detection device, a data element can be provided, retrieved or used.

According to the proposal made here, there is on a location-independent memory, a data element associated with the digital roll protocol.

In concrete terms, however, it is conceivable that the data element associated with the digital roll protocol is present on a data memory that is introduced in the electronic data detection device or is networked with the electronic data detection device for data exchange.

Advantageously, it can be achieved that the electronic data detection device can perform an identification of a roll or an identifier, in particular a barcode, a QR codes or a matrix code, can be read opto-electronically in a simple way, wherein when reading the code or the identifier a linkage to a data element is established, provided that a corresponding use authorization exists.

It can also be advantageously achieved that a data detection device ca read-in electromagnetically a RFID chip, which can be used to identify a product, a production machine, a further-processing machine or a transport vehicle and wherein when reading the RFID chip a link is produced with a data element, provided that a corresponding use authorization exists.

Furthermore, it is proposed that the electronic data detection device is performed to to present, to analyze and to edit an accessible information from a data element, in particular in the data element.

A conclusion on the change in the final properties of the end product from sheet materials as a result of the envisaged networking of the information exchange is currently only possible to a limited extent.

Advantages of the present invention are an increased level of information exchange, a process optimization of the value creation chain of plastic sheet material in the areas of raw materials, semi-finished product production, further-processing of semi-finished products, logistics and management of the value creation chain. So, for example, serial trough-running machines can be adapted to the individual characteristics of the goods. In particular, variations in the process parameters may be considered at one stage of the value creation chain in the following stages.

In addition, an optimized production planning and control of all relevant items can comprise a further-processing of B-ware in another not so demanding end product and lead to the fact that the rejects of goods can be reduced.

Process optimization across a single link-element in the value creation chain allows furthermore, that the energy requirement can be reduced until to the final product.

Overall, the invention can significantly contribute to improve significantly the efficiency within the value creation chain around the semi-finished sheet material product.

Preferably, the electronic data detection device is mobile, wherein it comprises a battery, a power connection or a voltage generator.

Thereby, advantageously, it can be achieved that the electronic data detection device can be used in self-sufficient manner by a stationary power transmission. In particular, the electronic data detection device is so lightweight and ergonomically dimensioned that it can be carried comfortably by a person and it is considered by people to be an accompanist.

The mobility of the electronic data detection device advantageously allows an easy accessibility also to identification codes, arranged in directly non-visible field of vision, or to identifiers or to RFID chips.

The mobility with respect to the presentation and analysis of an information of a data element is advantageous, because on the one hand, comparably simple tablet computer can work with the electronic data detection device and on the other hand possibility is given, that the presentation and/or the analysis of an can be shared with other people, by the simplicity of a tablet computer.

Furthermore, it is proposed here that the electronic data detection system comprises a context-based user interface and context-based user guidance.

Optionally, the electronic data detection device is stationary Installed on a production machine and/or a further-processing machine and/or a transport vehicle.

For example, inter alia, it is suggested that an electronic data detection device is directly attached to a production machine and/or a further-processing machine and/or a transport vehicle.

It is also conceivable that an, otherwise, mobile electronic data detection device is installed with a safety cord or a safety rope which is fixed to a production machine and/or a further-processing machine and/or a transport vehicle. Thereby, for example, it can be ensured that an electronic data detection device is always in stock at the place where information is normally provided or needed. This guarantees, among other things, a fast dealing with the synchronized exchange of goods and information, because, in particular in the introductory phase of the electronic data detection device, always one is on the place when needed.

Advantageously, thereby, it can be achieved that an electronic data detection device is always in that place available, where information should be generated and provided and should be retrieved and analyzed.

Preferably, the electronic data detection device is stationary installed on the semi-finished product and/or final product.

In particular, a miniature design of an electronic data detection device is proposed here, which does not have its own screen, but which needs a separate monitor for the presentation of information for displaying the information or which, and which sends, for the purpose of analysis and presentation and for the purpose of user guidance, information to an external tablet computer, a laptop, a stationary personal computer, or a smartphone.

Furthermore, it is proposed that the miniature design of an electronic data detection device has a data carrier that has at least one data element, so that information is always transported, in particular with the goods, due to the miniature design of an electronic data detection device.

Advantageously, it can be achieved that the miniature design of an electronic data detection device is so small and compact that it can be attached to a semi-finished product or to an end product, easily. Thereby, the miniature design of an electronic data detection device has, advantageously, such a lot of internally data memory, that, in a figurative sense, it can be transported like a digital leaflet with the semi-finished product, the product or the final product, and, thus, can include all information that can result within the value creation chain for sheet material.

Also, by the miniature version of an electronic data detection device it can be reached, that the relevant and interesting overlapping value creation chain information of the sheet material can stay always on the semi-finished product, the product or the final product, and stay where they are needed be searched.

Optionally, an electronic data detection device may comprise a trigger for transmitting and/or completing a data record, and thus a corresponding trigger can be provided.

A “trigger” is to be understood as a triggering event in individual cases.

The “data set” comprises a plurality of different data elements. Thus the data set can be referred, individually, in particular, to a predetermined amount of material, of semi-finished products or of products.

The data set can be used to record the different influences on a product in the production history. Ideally, the record captures—as already described—all relevant data on the product and/or its manufacturing process.

Once the trigger fires, a data element is added to the data record. This can occur locally by adding one or more of the previous or remaining data elements, and thus, the amended record thus is passed; or the new data element(s) are transmitted to a remote data processing unit, which comprises a data memory, wherein the data set is there supplemented and is there provided for further availability.

Regardless of whether the supplementing is centralized or decentralized, a plausibility check can be carried out, before a data element is added to the record.

Depending on the design, the trigger can trigger fully automatically or semi-automatically an action.

A fully automatic action causes the triggering to the trigger leads to a forced supplementation of the data record. This action is then, preferably by a user, unstoppable. As an example, it is thought about that case by which a data record is automatically supplemented with the humidity data or the ambient temperature data, if a film web is subjected to a further-treatment.

In a semi-automatic action—especially from the data detection device—it would be proposed to an operator to add a data element to the record. Either on confirmation or in case of lack of inhibition, the operator would do that adding.

The trigger can have a mechanical release. For example, it is conceivable that a transport vehicle, for example a pallet truck, recognizes by a push-button or by a weight sensor that it has been loaded or unloaded. Or it can be detected that a roll rotates, or a belt runs, or granules from a silo are running, etc. This can start the trigger.

If the trigger has an electronic trigger, in particular by means of an optical sensor and/or a radio-wave sensor, then it can respond to more varied events.

In particular, it is conceivable that an electronic coupling element, for data exchange with a machine, is provided. For example, this can be a proximity sensor such as a RFID chip or a magnet or can be a radio-wave emission, such as a Bluetooth data connection.

It is especially—so explicitly and not final—thought, to start the trigger at the following events: operator change, raw material change, production process leaves set limits, means of transport loading, pressure switch, weight sensor, order change, machine start-up, start of the good production, manual triggering for example for sampling, accelerometer, changing the production parameters within a production, deviation from a correlation outside a given tolerance window, variation of environmental parameters, or failure of machine components.

It should be expressly understood that the subject matter of the sixth aspect can be advantageously combined with the subject matter of the above aspects of the invention, namely cumulatively either individually or in any combination.

According to a seventh aspect of the invention, the object is solved with a plant for producing plastic sheet material, in particular a spunbond nonwoven, a meltblown nonwoven, a composite nonwoven, a blown film, a flat film, a plastic plate or a plastic panel, wherein an extruder is operated to plastify a plastic, wherein during production, a method according to the first aspect of invention and/or a method according to the second aspect of the invention and/or a method according to the third aspect of the invention and/or a method according to the fourth aspect of the invention is carried out and/or the plant is an electronic data detection device according to the fifth aspect of the invention.

It is understood that the benefits of a method for providing, retrieving and use of a data element in the value chain of a plastic sheet material for producing a final product—by means of a communication protocol and a data carrier for stage crossing exchange of a plurality of different data elements, to produce the final product within the value creation chain—and/or the benefits of a use of data to construct a production machine or a further-processing machine and/or the advantages of a method for improving a quality of a process, in particular a production process, a logistics process or a management process, within the value chain of plastic sheet material for producing a final product, wherein the data element—by means of the communication protocol and the data carrier for the stage crossing exchange of a plurality of different data elements—is retrievable and usable, and/or the advantages of a method for producing a plastic sheet material, wherein an extruder is operated for plasticizing a plastic, and/or the benefits of an electronic data detection device, for stage crossing providing, retrieving and using a data element in the value creation chain of a plastic sheet material for producing a final product, by means of a communication protocol for stage crossing exchange of a plurality of different data elements for producing the final product within the value creation chain, as described above, directly on a plant for producing a plastic sheet material, in particular a spunbond nonwoven, a meltblown nonwoven, a composite nonwoven, a blown film, a flat film, a plastic plate or a plastic panel, wherein an extruder for plasticizing a plastic is operated, wherein, during production, a method according to the first aspect of the invention and/or a method according to the second aspect of the invention and/or a method according to the third aspect of the invention and/or a method according to the fourth aspect of the invention is carried out and/or the plant is an electronic data detection device according to the fifth aspect of the invention, extend.

It should be expressly understood that the subject matter of the seventh aspect can be advantageously combined with the subject matter of the above aspects of the invention, namely cumulatively either individually or in any combination.

In this context, it should be emphasized explicitly that the “aspects of the invention” can be combined with each other so that any embodiment of an aspect of the invention can be realized in common with any embodiment of one or more aspects of the invention, insofar, case-by-case, two features are not contradictory to each other. Thus, the cumulating of the features of two (or any one of several) aspects of the invention is meant to be understood as expressly disclosed.

In the context of “optimization”, “optimize”, “improve”, “minimize”, “maximize” or similar is concretely pointed out that whenever a process or a property, in particular a substance property, a product property, a process property, a production process property, a logistics process property and/or a management process property, is optimized, improved, minimized, maximized, or comparable is performed, than this can be performed, in particular model-based. Thereby, in particular, it is conceivable the application of heuristic models, statistical models, directly or indirectly optimizing models, evolutionary strategies, evolutionary algorithms, models of differential evolution, neural nets or similar models. Furthermore, it is conceivable, inter alia, that self-learning models are used.

The evaluation of a data element can be model based. It comes into use, in particular, a heuristic model, a correlation-based model, an optimization model or another model for data analysis. Preferably comes with it a self-learning model for use. Furthermore, it is conceivable, inter alia, that a model accesses existing information or a model is model predictive. In particular, a model is model-predictive if it is a discrete-time dynamic model, which calculates the future behaviour of the process as a function of the input signals.

In the evaluation or analysis of a data element it is concretely conceivable, inter alia, that a method of machine learning is used. Under “machine learning” is referred the generation of knowledge from experience. Thereby, an artificial system learns from examples and can generalize these after completion of the learning phase. That means quite concretely, that not just the examples are learned by heart, but the artificial system recognizes patterns and regularities in the learning data. This allows the system to evaluate unknown data (learning transfer) or fail by learning of unknown data (overfitting).

The invention will be described below based on an exemplary embodiment in detail with reference to the drawing. It is shown:

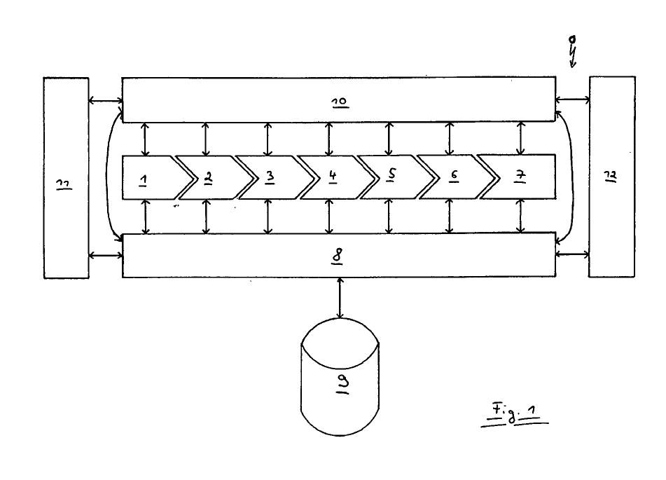

FIG. 1 is a schematic representation of a value creation of sheet material,

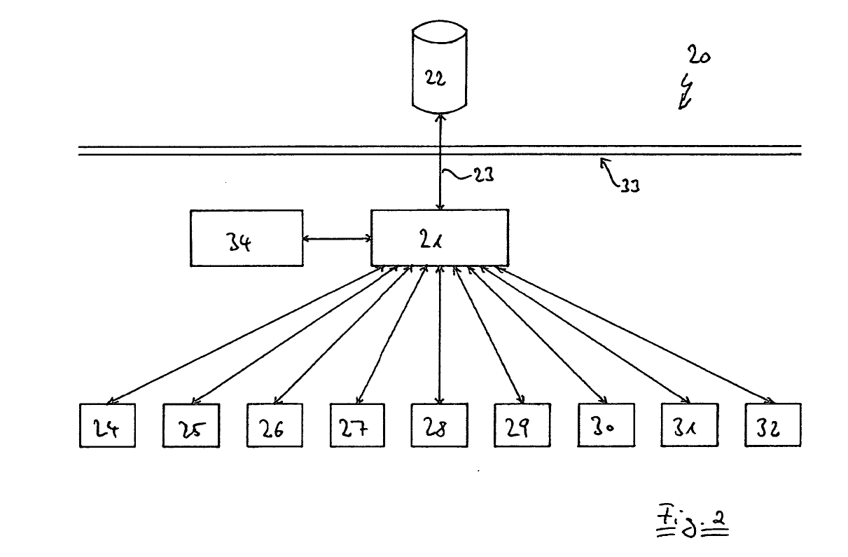

FIG. 2 shows in a schematic representation of a local- and overlapping value creation chain system for the synchronization of goods and information flows,

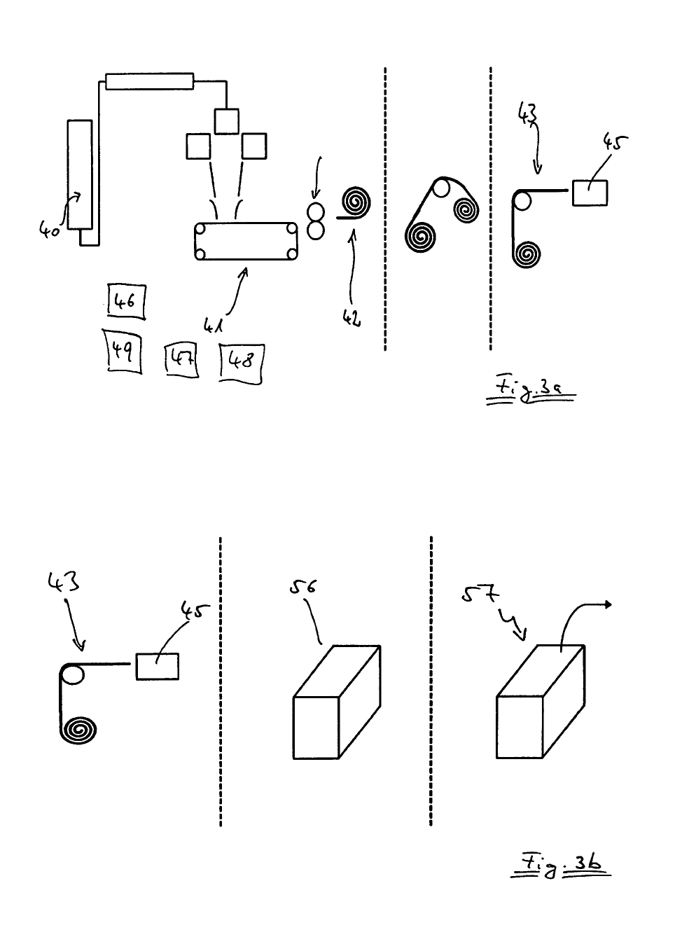

FIG. 3a, 3b show schematically the transfer of information using a communication protocol, wherein the FIGS. 3a, 3b show one exemplary embodiment, which, only for the reason of a better drawing, are here shown divided in two figure parts 3a, 3b,

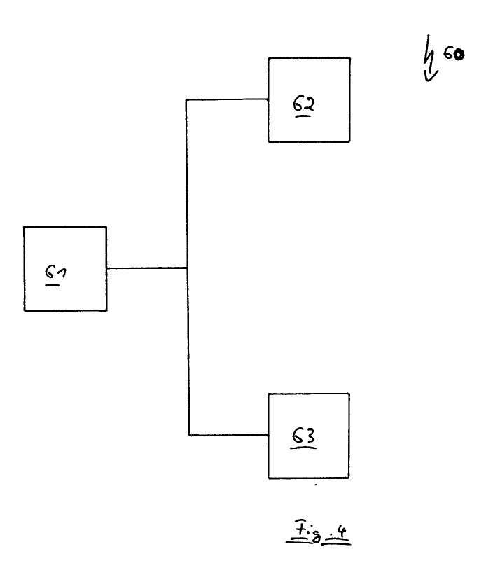

FIG. 4, 5 show schematically a separation or a union, as well

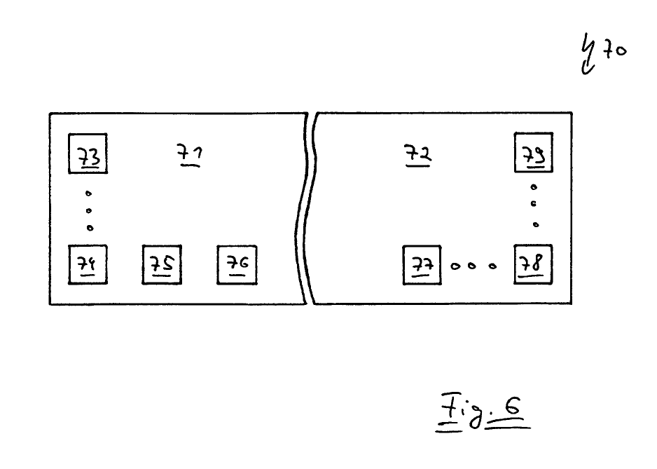

FIG. 6 shows schematically a sheet material.

The value creation chain 0 for sheet material (not shown) in FIG. 1 consists essentially of the value creation stages of a starting material 1, of a production machine 2, of a semi-finished product from sheet material 3, of a further-processing machine 4, of a final product 5, of a trade 6 and of an end consumer 7.

Thereby, the production machine 2 produces a semi-finished product from a starting material 1 of sheet material 3. Subsequently, the semi-finished product from sheet material 3 is transported to a further-processing machine 4, which produces from the semi-finished product of sheet material 3 a final product 5. Finally, the final product 5 is transported to the trade 6 and there purchased from the end user 7.

All value creation stages 1, 2, 3, 4, 5, 6, 7 of the value creation chain 0 can be linked for information exchange with an electronic data detection device 8. The electronic data detection device 8 may be linked with a location independent memory 9, which is adapted to store information regardless of location.

Furthermore, all value creation stages 1, 2, 3, 4, 5, 6, 7 of the value creation chain 0 can be connected with an overlapping value creation management 10. Thereby, the information exchange between the value creation stages 1, 2, 3, 4, 5, 6, 7 of the value creation chain 0 can performed directly with the overlapping value creation management 10 or indirectly via the electronic data detection device 8, wherein the electronic data detection device 8 also allows the location-independent memory 9 for the exchange information to be connected with the overlapping value creation management 10.

Furthermore, each value creation stage 1, 2, 3, 4, 5, 6, 7 of the value creation chain 0 and/or the location-independent memory 9 can, each, for the exchange of information, be connected indirectly via the electronic data detection device 8 with the research & development 11 and/or the central data analysis 12.

In particular, the electronic data detection device 8 is performed to provide, retrieve and use a data element (not shown) by means of a communication protocol (not shown).

In particular, a data element (not shown) may include material properties (not shown), product properties (not shown), process properties (not shown) and market properties (not shown), wherein the information (not shown) of a data element (not shown) can be used for the overlapping value creation chain synchronization (not shown) of a goods—(not shown) and information flow (not shown).

Furthermore, the information (not shown) of a data element (not shown) can be used to optimize the overlapping value creation chain (not shown) of a quality (not shown) of a process (not shown), in particular a production process (not shown), a logistics process (not shown) or a management process (not shown) within the value creation chain 0 of plastic sheet material (not shown).

The system for synchronization of good- and evolutionary flows 20 in FIG. 2 is based essentially on a data detection device 21 and a memory 22. The data detection device 21 and the speakers 22 are so interconnected via a data detection connection 23, whether wired or wireless, that they can exchange information (not shown here) in both directions.

The data detection device 21 is performed to detect data from a wide variety of processes and/or transmit data to the processes, such as—but not finally enumerated-from or via a raw material 24, a production plant 25, an operator 26, a roll ID 27, a further-processing machine 28, a laboratory 29, an entity or process from transportation or logistics 30, a warehouse 31 or a management process 32.

In the figure, the data detection device 21 is to be understood as a logical entity. In the practice, for example, a single data detection device 21 can be performed to be capable for data exchange of several of the processes 24 to 32, but it is just as well conceivable that a data detection device 21 can communicate with only a subset thereof, for example, even only with a single process of the processes 24 to 32.

Using the example of the raw material 24, it is conceivable that the raw material carries a special marking, for example a batch of granules can carry a unique identifier, or, for example, can make a recipe recognizable, and a specialized or generally performed data detection device 21 communicates with the data carrier on the raw material 24. The data detection device 21 recognizes the identifier (not shown) of the raw material 24. Via the identifier (i.e. the ID) of the raw material 24, the data detection device 21 can generate a data element (not shown). The data element can then stored by the data detection device 21 into the memory 22.

Preferably, the memory 22 is arranged centrally, i.e. spatially remote from the decentralized processes 24 to 32, thus also removed from the respectively associated data detection devices 21.

To make possible, that the data detection device 21 can write or has any access to the memory 22, the data transmission connection 23 must, preferably, take an authentication hurdle 33. Here it is possible to fall back on common authentication possibilities used in electronic registration from the prior art.

To make possible, that the from the data detection device 21 to memory 22 transmitted information or properties or data elements are more recognizable for the operator, or from the memory 22 retrieved data can be better recognized, a data visualization- and evaluation unit 34 may be provided for the operating person.

Typically, a silo 40, a spunbond nonwoven plant 41 (here shown as an example of a plant in FIG. 3, divided into subfigures 3a/3b) and a sheet material 42 in the process chain are connected in a network, and this network communicates with a management system 46. Alternatively, the silo 40, the spunbond nonwoven plant 41 and the sheet material 42 are divided into network segments in the process chain, which in turn are connected with the management system 46.

Depending on the design, the connection can be secured. This can be done by cryptography methods. Therefore, the transfer takes place via data blocks and messages, i.e. the data are directly available to the machine control or, if required, can be generated or used or subscribed by the controller.

All data are stored chronologically via a communication protocol in a memory 49. The process properties are transmitted, for example, as OPC-UA IEC 62541/DIN EN 62541 part 8, MQTT (MQTT since 2016 an ISO standard (ISO/IEC 20922)) or AMQP (ISO/IEC 19464), alternatively as one, defined by the manufacturer of the software interface, data frame or another, selected by the applicant, message format. It is characteristic that the time information is attached to the protocol. The storage in the memory 49 is done chronologically, in addition according to the type of data. The location of data storage by the memory 49 and use in the management system 46 may be spatially separate. The distribution follows the purpose of use and the type of data.

The transfer of the data into the further steps of the process chain takes place via communication protocols, which are transferred either chronological, chronological/positional with the sheet material, the roll goods or the final product, or which can be made available by means of an unique/individual identifier from the memory 49 by means of the management system 46, locally or globally. The choice of the identifier is also directed, but not exclusively, by the nature of the process, continuous or batch/cargo process.

A feature of these communication protocols is that these are adapted on the standards of the receiving partners so that only the relevant data for the recipient is used, however, and are, in total, available for further evaluation 47 by a development department 48. The processing entity can, in addition, provide the relevant data of the desired process step to the possible recipients. The recipient makes thereof the selection.

In a special case of the transfer of a nonwoven roll from a winder to a rewinder/a confection machine are transferred in addition to the roll characteristics such as run length, width, in particular inspection data, to enable a selection of rejects or B-ware and to allow further optimization in the further-processing.

In a further parallel step, the inspection data can be used in real time in order to optimize the production setting of the spunbond plant 41. For this, the process data are analyzed in memory 49 and the results are returned to the controller of the spunbond plant 41. For this, the communication protocols have a low latency, or they have features that enable the consideration of latencies.

Finally, the memory will be provided with data of the final packaging and delivery, so that a complete record of production data, product characteristics and packaging data is present.

With that it is possible that:
The supply chain can be supported to e.g. to arrange transport means; and/or
by means of a communication protocol, order-relevant data are returned to an EPA system; and/or
a data record can be provided on a mobile storage medium or by identifier globally (cloud or similar) to the further-processor such as the diaper production 43 (German: Diaperproduktion); (“digital reel log”).

After the production of a final product, this end product has its own identifier. Typically, data records for analysis and logistics processes can be determined using this identifier.

With regard to the aspect of the invention of the production plant, it is considered the following example:

Production of a spunbond nonwoven made of PP

First, a conveyance from the silo 40 is performed, and thus, a transfer of the associated raw material data to the spunbond plant 41.

Solidifying with a calender 50 and winding on a winder leads to the sheet material 42. The transfer of the finished roll to a rewinder follows, in particular with the measured inspection data (the criterion “fault-free goods yes/no” can be included), process data and from the process parameters calculated characteristic data. The winding cores are coded.

It follows: wrapping the sheet material in the desired confection, simultaneous marking of the B-Ware, and removing the rejects. In the rewinder the code of the used winding core is detected. This code is then sufficient to provide to the rewinder access to all relevant data from the production machine. The rewinder is for this purposes involved in the network of the production plant and thus is authenticated by means of the identifier that can be derived from the code of the winding core and can get the relevant data. The produced, finished rolls are marked by labels. On these labels, for example, a QR or bar code is the identifier of that roll.

It follows: Transfer of ready-made sheet material (roll-ware) to a diaper machine. By means of the, on the roll label applied, identifier, which is detected by a suitable reader, the data, relevant for the diaper machine, are available via a software interface. The transmitted data contains the physical properties (e.g. strength, elongation calculated) and roll characteristics, diaper production 43 to diaper 45.

Packed according to the client's specifications (brand owner or white label) included a Lot ID (i.e. batch ID). The Lot ID of a diaper identifies it and allows, by means of further evaluation 47 in the memory 49, the representation of the entire value creation chain. This ensures a particularly process-reliable pleasant use 57 of the ready-to-sell diaper 56.

With a feedback of the end customer to the diaper manufacturer 44 about a lack of quality he can achieve full traceability to the silo via the data records.

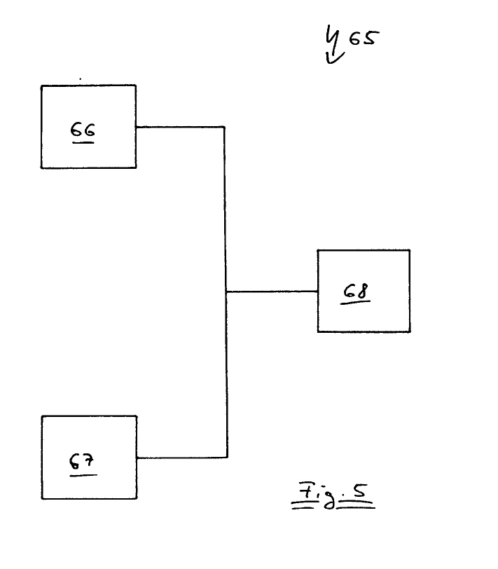

FIGS. 4 and 5 show the merging process (for example by means of a calender) or the division process (for example, using a slitter).

As shown schematically in FIG. 5, sheet material 70 can carry mainly on a front web end 71 and/or at a rear web end 72 redundant identifiers 73 . . . 79. The sheet material can then be separated, for example by means of a slitter, so that the parts produced in each case still carry identical identifiers 73 . . . 79 and thus the process upstream in the value chain still remains traceable.

Ideally, when dividing sheet material 70 with redundant identical identifiers 73 . . . 79, the process adds to the produced pieces different sub-identifier (not shown), so that from there the different destinies can be followed.

### LIST OF REFERENCE NUMBERS USED

FIG. 1
0 value creation chain
1 starting material
2 production machine
3 semi-finished products from sheet material
4 further-processing machine
5 final product
6 trade
7 end consumers
8 electronic data detection device
9 location-independent memory
10 overlapping value creation management
11 research & development
12 central data analysis
FIG. 2
20 system
21 data detection Device
22 memory
23 data detection connection
24 raw material
25 production plant
26 operator
27 roll
28 further-processing machine
29 laboratory
30 transport/logistics
31 warehouse
32 management process
33 authentication hurdle
34 data visualization and evaluation unit
FIG. 3
40 silo
41 spunbond plant
42 sheet material
43 diaper production
44 diaper manufacturer
45 diaper
46 management system
47 further evaluation
48 development department
49 memory
50 calender
56 ready-to-sell diaper
57 use of the ready-to-sell diaper
FIG. 4
60 division process
61 run-in roll
62 first further-run-in part
63 second further-run-in part
FIG. 5
65 unification process
66 run-in part
67 second run-in part
68 unites continue-run-in roll
FIG. 6
70 sheet material
71 front web end
72 rear web end
73 . . . 79 identifier

1. Method for providing, retrieving and using a data element in the value creation chain of a plastic sheet material for producing a final product,
by means of a communication protocol and a data carrier for the stage overlapping exchange of a plurality of different data elements to produce the final product within the value creation chain,
characterized in that
the data element is used in the value creation chain in a stage overlapping way, namely, provided from a first stage by means of the communication protocol on the data carrier and retrieved from a second stage by means of the communication protocol from the data carrier and used on a machine of the second stage.

2. Method according to claim 1, characterized in that the data element has a substance property or substance properties, in particular a substance property or substance properties of a product, in particular of a starting material and/or of a semi-finished product and/or of a final product.

3. Method according to claim 1,
characterized in that the
data element has a product property or product properties, in particular a product property or product properties of a starting material and/or a semi-finished product and/or a final product.

4. Method according to claim 1,
characterized in that the data element has a process property or process properties, in particular a production process property or production process properties, and/or a logistics process property or logistics process properties, and/or a management process property or management process properties.

5. Method according to claim 1,
characterized in
the data element has a market characteristic or market characteristics.

6. Method according to claim 1,
characterized in
that the exchange of one or more data elements is performed across locations, in particular, that the exchange of one data element is worldwide possible.

7. Method according to claim 1,
characterized in that the exchange of one or more data elements is performed across parties, especially across companies.

8. Method according to claim 1,
characterized in
that the exchange of one or more data elements is performed using a standardized software interface.

9. Method according to claim 1,
characterized in
that both the first stage and the second stage can read and/or can write the data element.

10. Method according to claim 1,
characterized in
that the use of the data element takes place on the part of the second stage for the further-processing of that product, by which due its production or manufacturing,
at the first stage, the data element has been generated and has been provided in the data memory store, wherein the second stage is arranged chronologically after the first stage.

11. Method according to claim 1,
characterized
that the order of the stages is not chronological, wherein the first stage like also the second stage each can be a different arbitrary and not necessarily adjacent stage in the value creation chain.

12. Method according to claim 1,
characterized
that the product, in particular the final product, is provided with an individual product identifier and comprises this subsequently.

13. Method according to claim 1,
characterized
that a production machine for plastic sheet material is provided with an individual production machine identifier and comprises this subsequently.

14. Method according to claim 1,
characterized in
that a further-processing machine for plastic sheet material is provided with an individual further-processing machine identifier and comprises this subsequently.

15. Method according to claim 1,
characterized in that
a transport vehicle for transporting the product is provided with an individual transport vehicle identifier is provided and comprises this subsequently.

16. Method according to claim 1,
characterized in
that the data element is displayed and/or is detected and/or is linked and/or is provided and/or is used, via a data detection device with the product and/or with the production machine and/or with the further-processing machine and/or with the transport vehicle

17. Method according to claim 1,
characterized in
that the product identifier and/or the production machine identifier and/or the further-processing machine identifier and/or the transport vehicle identifier is read opto-electronically and/or electromagnetically.

18. Method according to claim 1,
characterized in
that the data carrier is a location-independent data memory that is available crossing location and/or crossing parties, wherein the data carrier can be a crossing location and/or a crossing parties available data cloud.

19. Method according to claim 1,
characterized in
that the plastic sheet material is a spunbond nonwoven.

20. Method according to claim 1,
characterized in that the
plastic sheet material is a meltblown nonwoven.

21. Method according to claim 1,
characterized in that the
plastic sheet material is a composite nonwoven.

22. Method according to claim 1,
characterized in that the
plastic sheet material is a blown film.

23. Method according to claim 1,
characterized in that the
plastic sheet material is a flat film.

24. Method according to claim 1,
characterized in that the
plastic sheet material is a plastic plate.

25. Method according to claim 1,
characterized in that the
plastic sheet material is a plastic panel.

26. Method for classifying a process quality by which in the various stages comprising value creation chain of a plastic sheet material, for example a blown film web, a flat film web or a nonwoven web, for producing a final product, for example a packaging film, an agricultural film, a thermoforming film, a plastic plate or a diaper, wherein the classifying is performed due to information and/or properties of the stages and/or a raw material and/or a semi-finished product and/or the final product,
in particular by means of a method according to claim 1,
in such a way that for at least one information or property, preferably for several, particularly preferably for all, a good area and/or a bad area can be defined,
whereby, along the stages, information and/or properties are determined and
preferably authenticated by means of a mark or an identifier—are transmitted and stored as data element locally or, above all, remotely in a data record via a communication protocol, namely, either as the pure information and/or property, or just as
included in the good area or bad area, or both together, or depending on the stage in different way,
whereby, based on the data record is performed the classifying of a process of the stage, of a process chain along several stages, the final product and/or of a manufacturer,
preferably with at least one class from the classes “in all levels in the area”, “in a certain number of classes in the good area”, “in certain particularly important classes in the good area”.

27. Use of data provided by a method according to claim 1, for constructing a production machine or a further-processing machine or a plant, which is used in the value creation chain of plastic sheet material, in particular a
spunbond nonwoven, a meltblown nonwoven, a composite nonwoven, a blown film, a flat film, a plastic plate or a plastic panel, to produce a final product.

28. Method for improving a quality of a process, in particular a production process, a logistics process or a management process, within the value creation chain of plastic sheet material, in particular within the value creation chain of a spunbond nonwoven, a meltblown nonwoven, a composite nonwoven, a blown film, a flat film, a plastic plate or a plastic panel, for producing a final product,
wherein a data element retrieved and used by means of a communication protocol and a data carrier for stage crossing exchange of a variety of different data elements,
characterized in that
a quality of the process is described depending on information of the data element, and thus, this quality of the process is described as a function of the data element,
the data element is used to improve the quality of the process,
and by improving the quality of the process, the process is changed, so that a desired property, in particular a substance property, a product property, a process property or a market property, is strengthened in its manifestation/dimension and/or an undesirable property, in particular a substance property, a product property, a process property or a market property, is reduced in its manifestation/dimension.

29. Method according to claim 28, characterized in that the quality of a production process, and thus the quality of the product production is improved.

30. Method according to claim 28,
characterized in that
the quality of product further-processing is improved.

31. Method according to claim 28,
characterized in that
the quality of a process chain is improved, thus the quality of a process chain courses.

32. Method according to claim 28,
characterized in that
the quality of a process setting is improved.

33. Method according to claim 28,
characterized in that
the product quality is improved by changing a machine setting.

34. Method according to claim 28,
characterized in that
product quality is improved by changing a process setting.

35. Method according to claim 28,
characterized in that
the quality is improved by a selection of a starting substance, thus through a selection of starting materials.

36. Method according to claim 28,
characterized in that
the quality of the production process is improved by reducing energy consumption.

37. Method according to claim 28,
characterized in that
the quality of the management process is improved by analyzing one or more data elements to generate expert knowledge.

38. Method according to claim 28,
characterized in that
the quality of a production planning is improved.

39. Method according to claim 28,
characterized in that
the quality of a production control is improved.

40. Method according to claim 28,
characterized in that
the quality through a control of research and development activities is improved.

41. Method according to claim 28,
characterized in that
the quality is improved by optimizing one distribution path, especially several or all distribution paths.

42. Method according to claim 28,
characterized in that
the quality is improved by selecting a storage location, especially several or all storage locations.

43. Method according to claim 28,
characterized in that
the quality is improved by optimizing a storage.

44. The method according to claim 28,
characterized in that
the quality is improved by optimizing transport costs.

45. Method according to claim 28,
characterized in that
the quality is improved by optimizing a logistics process.

46. Method according to claim 28,
characterized in that
the quality is improved by optimizing management costs.

47. Method for producing a plastic sheet material, in particular a spunbond nonwoven, a meltblown nonwoven, a composite nonwoven, a blown film, a flat foil, a plastic plate or a plastic panel, wherein an extruder is operated for plasticizing a plastic,
characterized in that
during the producing, a method according to one of the preceding claims is carried out.

48. Electronic data detection device,
for the step crossing provision, retrieval and use of a data element in the value creation chain of a plastic sheet material, in particular a spunbond nonwoven, a meltblown nonwoven, a composite nonwoven, a blown film, a flat film a plastic plate or a plastic panel, to produce a final product,
by means of a communication protocol for the step crossing exchange of a plurality of different data elements for producing the final product within the value creation chain,
characterized in that
the data detection device has a programming for carrying out a method according to claim 1,
wherein the data detection device is performed for writing a data element, for providing the data element and/or for reading a data element for retrieval of the data element, namely, in each case by means of the communication protocol.

49. Electronic data detection device according to claim 48, characterized in that the electronic data detection device is mobile, whereby it comprises a battery, a power connection or a voltage generator.

50. Electronic data detection device according to claim 48, characterized in that the electronic data detection device is installed stationary on a production machine and/or a further-processing machine and/or a transport vehicle.

51. Electronic data retrieval device according to claim 48, characterized in that the electronic data detection device is installed stationary on the semi-finished product, on the product and/or on the final product.

52. Electronic data logging apparatus according to claim 48,
characterized in that a trigger is provided for transmitting and/or completing a data record.

53. Electronic data detection device according to claim 52, characterized in that the trigger has a mechanical release.

54. Electronic data detection device according to claim 52, characterized in that the trigger has an electronic release, in particular by means of an optical sensor and/or a radio-wave sensor.

55. Electronic data logging apparatus according to claim 52,
characterized in that an electronic coupling member for data exchange with a machine is provided.

56. Plant for producing a plastic sheet material, in particular a spunbond nonwoven, a meltblown nonwoven, a composite nonwoven, a blown film, a flat foil, a plastic plate or a plastic panel, wherein a extruder is operated for plasticizing a plastic,
characterized in that
during the producing, a method according to claim 1 is carried out.
